(19) United States
(12) Patent Application Publication
(10) Pub. No.: US 2026/0018081 A1
(43) Pub. Date: Jan. 15, 2026

(54) INFORMATION PROCESSING SYSTEM, INFORMATION PROCESSING METHOD, AND NON-TRANSITORY COMPUTER-READABLE STORAGE MEDIUM STORING INFORMATION PROCESSING PROGRAM

(71) Applicant: Yamaha Corporation, Hamamatsu (JP)

(72) Inventors: Keizo HARADA, Hamamatsu (JP); Hideaki TAKEHISA, Hamamatsu (JP); Masakazu KATO, Hamamatsu (JP)

(21) Appl. No.: 19/335,256

(22) Filed: Sep. 22, 2025

Related U.S. Application Data
(63) Continuation of application No. PCT/JP2024/008040, filed on Mar. 4, 2024.

(30) Foreign Application Priority Data
Mar. 24, 2023 (JP) 2023-047624

(51) Int. Cl. G09B 15/00; G06Q 10/20; G06T 7/00

(52) U.S. Cl. CPC G09B 15/00; G06Q 10/20; G06T 7/0004

(57) ABSTRACT

An information processing system includes a processor configured to execute a first acquisition unit, a second acquisition unit, a current status information generation unit, and a support processing unit. The first acquisition unit acquires a captured image obtained by photographing a musical instrument. The second acquisition unit acquires information on a consultation matter relating to a function of the musical instrument. The current status information generation unit generates, based on the captured image, current status information relating to a current status of the musical instrument. The current status information includes information relating to at least one or more of a configuration of the musical instrument, state of the musical instrument, or the installed location of the musical instrument. The support processing unit generates and outputs support information for resolving the consultation matter based on information on the consultation matter and the current status information.

### CROSS-REFERENCE TO RELATED APPLICATIONS

This application is a continuation application of International Application No. PCT/JP2024/008040, filed on Mar. 4, 2024, which claims priority to Japanese Patent Application No. 2023-047624 filed in Japan on Mar. 24, 2023. The entire disclosures of International Application No. PCT/JP2024/008040 and Japanese Patent Application No. 2023-047624 are hereby incorporated herein by reference.

### BACKGROUND

### Technical Field

This disclosure generally relates to an information processing system, an information processing method, and a non-transitory computer-readable storage medium storing information processing an information processing program, which can be applied to a support system relating to musical instruments.

### Background Information

Japanese Laid-Open Patent Application No. 2004-252391 and Japanese Laid-Open Patent Publication No. 2003-208089 disclose a system that enables teachers to communicate with, and provide lessons to, students via a network, for the purpose of improving performance skills.

### SUMMARY

There is a demand for technology that can support not only improving performance skills but also resolving consultation matters relating to musical instruments.

In consideration of the circumstance described above, one object of this disclosure is to provide an information processing system, an information processing method, a non-transitory computer-readable storage medium storing information processing an information processing program, and an information processing device that can efficiently support resolution of consultation matters relating to functions of musical instruments.

In order to achieve the object described above, an information processing system according to one embodiment of this disclosure comprises a processor configured to execute a plurality of units that include a first acquisition unit, a second acquisition unit, a current status information generation unit, and a support processing unit. The first acquisition unit is configured to acquire a captured image obtained by photographing a musical instrument. The second acquisition unit is configured to acquire information on a consultation matter relating to a function of the musical instrument. The current status information generation unit is configured to generate, based on the captured image, current status information relating to the current status of the musical instrument. The current status information including information relating to at least one or more of the configuration of the musical instrument, the state of the musical instrument, or the installed location of the musical instrument. The support processing unit is configured to generate and output support information for resolving the consultation matter based on information on the consultation matter and the current status information.

An information processing method according to one embodiment of this disclosure, which is executed by a computer system, comprising acquiring a captured image obtained by photographing a musical instrument, acquiring information on a consultation matter relating to a function of the musical instrument, generating, based on the captured image, current status information relating to a current status of the musical instrument, including information relating to at least one or more of a configuration of the musical instrument, state of the musical instrument, or installed location of the musical instrument, and generating and outputting support information for resolving the consultation matter based on the information on the consultation matter and the current status information.

A non-transitory computer-readable storage medium storing a program according to one embodiment of this disclosure causes a computer system to perform an information processing method, which comprises acquiring a captured image obtained by photographing a musical instrument, acquiring information on a consultation matter relating to a function of the photographed musical instrument, generating, based on the captured image, current status information relating to a current status of the musical instrument, including information relating to at least one or more of a configuration of the musical instrument, the state of the musical instrument, or the installed location of the musical instrument, and generating and outputting support information for resolving the consultation matter based on information on the consultation matter and the current status information.

### BRIEF DESCRIPTION OF THE DRAWINGS

FIG. 1 is a schematic diagram showing a configuration example of an instrument-related support system according to a first embodiment.

FIG. 2 is a block diagram showing an example of a functional configuration of a server device.

FIG. 3 is a flowchart showing an example of a basic operation of the server device.

FIG. 4 is a diagram showing one example of support history information stored in a support history information DB.

FIG. 5 is a schematic diagram showing another example of support history information.

FIG. 6 is a diagram showing one example of FAQ information stored in a FAQ information DB.

FIG. 7 is a schematic diagram showing one example of a procedure image.

FIG. 8 is a schematic diagram showing one example of shooting guide information.

FIG. 9 is a schematic diagram showing another example of shooting guide information.

FIG. 10 is a schematic diagram showing a configuration example of an instrument-related support system according to a second embodiment.

FIG. 11 is a schematic diagram showing a configuration example of an instrument-related support system according to a third embodiment.

FIG. 12 is a block diagram showing an example of a hardware configuration of a computer that can be used as a consultee-side terminal, a support-side terminal, and a server device.

### DETAILED DESCRIPTION OF THE EMBODIMENTS

An embodiment according to this disclosure will be described below with reference to the drawings as appropriate. It will be apparent to those skilled from this disclosure that the following descriptions of the embodiments are provided for illustration only and not for the purpose of limiting the invention as defined by the appended claims and their equivalents.

### First Embodiment

### Instrument-Related Support System

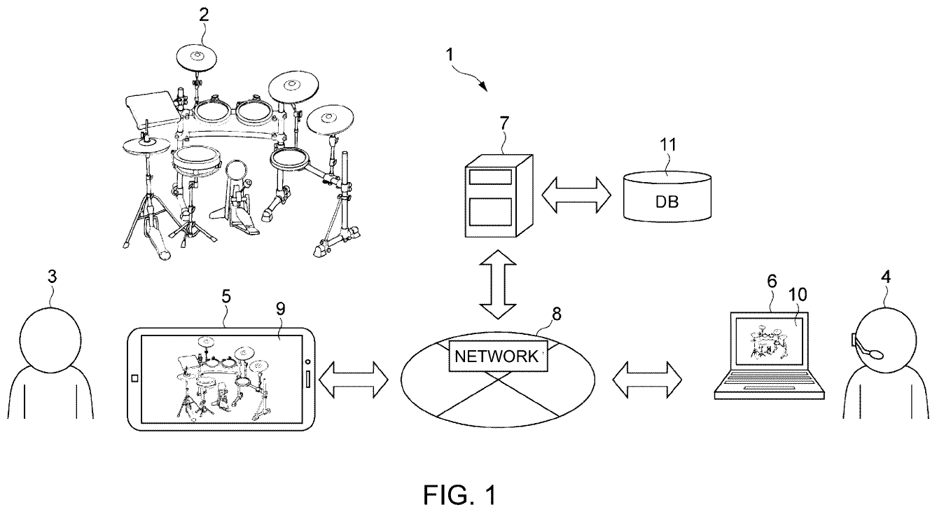

FIG. 1 is a schematic diagram showing a configuration example of an instrument-related support system according to a first embodiment of this disclosure. An instrument-related support system 1 can realize efficient support for solving various consultation matters relating to a musical instrument 2. In the example shown in FIG. 1, an electronic drum set is illustrated as the musical instrument 2, but the type of the musical instrument 2 is not limited thereto, and support by the instrument-related support system 1 can be provided for any musical instrument.

For example, a player 3 playing the musical instrument 2 can use the instrument-related support system 1 to receive support for resolving various consultation matters. For example, highly accurate support can be received on the spot with the musical instrument 2 in hand.

People who can use the instrument-related support system 1 are not limited to the player 3 of the musical instrument 2. Persons who can have consultation matters relating to the musical instrument 2, such as family and friends of the player 3, also can use the instrument-related support system 1.

The instrument-related support system 1 can also be used by support staff 4 of an instrument manufacturer that provides so-called user services to the player 3 of the musical instrument 2. The support staff 4 can use the instrument-related support system 1 to acquire information useful for support work, making it possible to provide high-quality support work to the player 3 and the like. It also becomes possible to reduce workload relating to the support work.

In the present disclosure, a “user” shall refer to a person who can use the instrument-related support system 1 regardless of whether the person is in the position of seeking consultation or providing support. In addition, a user in the position of seeking consultation is referred to as “consultee-side user.” A user in the position of supporting the resolution of a consultation matter is referred to as “support-side user.”

Any person for whom a consultation matter could arise can be the “consultee-side user,” such as a player of the musical instrument 2, an owner of the musical instrument 2, family and acquaintances thereof, someone who lives in a space in which the musical instrument 2 is present, a person who lives near the space in which the musical instrument 2 is present, a person asked to dispose of the musical instrument 2, and the like. The “consultee-side user” can be simply referred to as the consultee.

Any person who can be asked for advice relating to the musical instrument 2 can be a “support-side user,” such as the support staff 4 of an instrument manufacturer, etc., on-site staff of an instrument manufacturer, etc., a music teacher at a school, a teacher at a music school, a salesclerk at a music store, and the like.

The “consultee-side user” and the “support-side user” can use the instrument-related support system 1 for resolving various consultation matters. That is, the instrument-related support system 1 is a system that can exhibit advantageous effects with respect to both the “consultee-side user” and the “support-side user.”

There can be cases in which players of the musical instrument 2 (for example a senior and a junior player) can be in a relationship in which one is the side seeking consultation and the other is the side providing consultation. In such a case, the player on the side providing consultation can use the instrument-related support system 1 as the “support-side user.”

In other words, a player of the musical instrument 2, an owner of the musical instrument 2, family and acquaintances thereof, someone who lives in a space in which the musical instrument 2 is present, a person who lives near the space in which the musical instrument 2 is present, a person asked to dispose of the musical instrument 2, and the like can also use the instrument-related support system 1 as a “support-side user.”

In addition, a teacher at a music school can themselves want to seek consultation relating to a musical instrument. In such a case, the music school teacher can also use the instrument-related support system 1 as a “consultee-side user” to seek consultation from the support staff of an instrument manufacturer, etc.

In other words, any person who can be asked for advice with respect to the musical instrument 2, such as the support staff of an instrument manufacturer, etc., on-site staff of an instrument manufacturer, etc., a music teacher at a school, a teacher at a music school, or a salesclerk at a music store, can also use the instrument-related support system 1 as a “consultee-side user.”

As shown in FIG. 1, in the present embodiment, the instrument-related support system 1 comprises a consultee-side terminal 5, a support-side terminal 6, and a server device 7.

The consultee-side terminal 5, the support-side terminal 6, and the server device 7 are connected to each other via a network 8. The network 8 is constructed by the Internet, a wide area communication network, or the like. In addition, any wide area network (WAN), local area network (LAN), etc., can be used, and the protocol for constructing the network 8 is not limited.

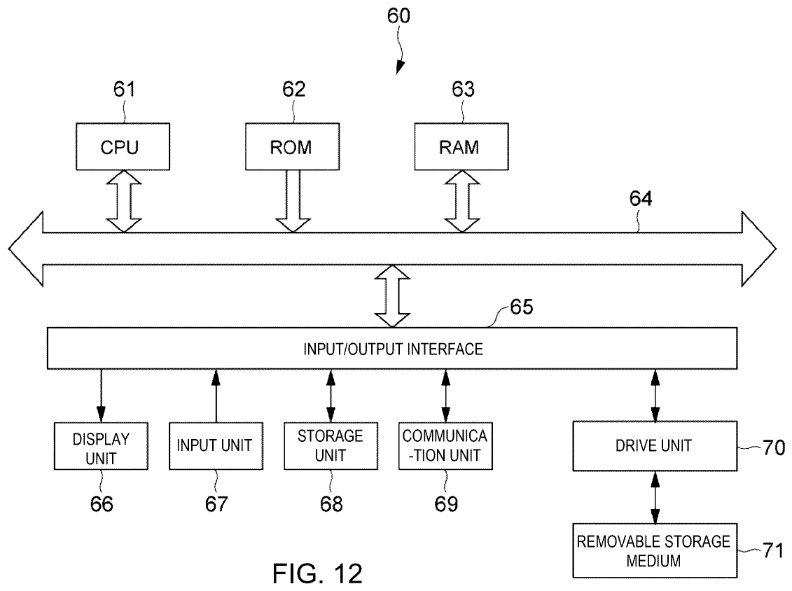

The consultee-side terminal 5, the support-side terminal 6, and the server device 7 include hardware required by a computer, for example, at least one or more processors such as CPU (Central Processing Unit), GPU (Graphics Processing Unit), and DSP (Digital Signal Processor), memory (computer memory) such as RAM (Random Access Memory) and ROM (Read Only Memory), and a storage device such as HDD (Hard Disk Drive) (refer to FIG. 12). The processor loads into the RAM and executes a program according to the present technique stored in the storage unit or the memory, thereby executing the information processing method according to the present technique (consultation matter solution support method).

In addition, in the present embodiment, a computer having an imaging function is used as the consultee-side terminal 5. In the example shown in FIG. 1, a smartphone equipped with a camera (not shown) is used as the consultee-side terminal 5.

A digital camera equipped with an image sensor, such as a CMOS (Complementary Metal-Oxide Semiconductor) sensor or a CCD (Charge Coupled Device) sensor, is used as the camera. In addition, an imaging device having any configuration can be provided.

The computer having an imaging function is not limited to a smartphone, and any configuration can be employed. For example, a tablet terminal, a head mounted display (HMD) such as AR (augmented reality) glasses or VR (virtual reality) glasses, a PC, etc. can be used.

In addition, in the present embodiment, a touch panel 9 is provided in the smartphone, which is the consultee-side terminal 5. The touch panel 9 functions as a display unit and an input unit. The touch panel 9 displays various image information, such as icons, text, GUI (graphical user interface), captured images, etc. In addition, in the present embodiment, AR display is also possible in which an AR object (virtual image) is displayed superimposed on a real object.

In addition, in the present disclosure, images include both still images and moving images (video). In the present embodiment, the camera of the consultee-side terminal 5 is able to capture, as the captured image, moving images including sound information.

For example, as shown in FIG. 1, the camera is able to capture an image so as to include the entirety of an electronic drum set, which is the musical instrument 2. Of course, the capturing is not limited thereto; a portion of the musical instrument 2 can be enlarged and photographed, or the musical instrument 2 can be photographed from various angles, such as from the front, from above, from the left or right, or from an oblique direction.

In addition, the consultee-side terminal 5 can be fixed to a prescribed location and capture performance images of the player 3 playing the musical instrument 2. The performance images constitute a video containing performance sounds of the musical instrument 2. In addition, the musical instrument 2 can be photographed so as to include peripheral devices used together with the musical instrument 2. Of course, a peripheral device alone may be enlarged and photographed.

In addition, the player 3 can carry out various touch operations and text input operations, etc., with respect to a GUI (Graphical User Interface) or icons, etc., displayed on the touch panel 9. It is thereby possible for the player 3 to input various information. In addition, the consultee-side terminal 5 can be equipped with various devices, such as a microphone, a speaker, a GPS (Global Positioning System), an inertial measurement unit (IMU) sensor, and the like.

In addition, a computer equipped with a display 10 that can display various image information is used as the support-side terminal 6. In the example shown in FIG. 1, a laptop computer is used as the support-side terminal 6. The support-side terminal 6 is not limited thereto; any computer such as a smartphone, a tablet terminal, a head mounted display (HMD) such as AR glasses or VR glasses, etc., can be used.

In addition, in the present embodiment, the consultee-side terminal 5 and the support-side terminal 6 are each provided with a call function. A call can be made between the player 3 and the support staff 4. The specific configuration, method, etc., for allowing calls between the two devices is not limited, and any configuration and method can be employed.

The server device 7 is configured to realize the instrument-related support system 1, and any computer such as a PC can be used. As shown in FIG. 1, in the present embodiment, a database (DB) 11 that can be accessed by the server device 7 is constructed. The DB 11 functions as the storage unit and stores various information relating to the instrument-related support system 1. The DB 11 can be constructed in a storage device provided in the server device 7, or constructed in a storage device configured outside of the server device 7.

For example, the player 3 downloads, onto the consultee-side terminal 5, an application (application program) for using the instrument-related support system 1. For example, the player 3 inputs information such as an ID and a password to create an account for using the instrument-related support system 1. Of course, creation of an account need not be mandatory.

The player 3 starts the application for using the instrument-related support system 1. Then, the player 3 selects an instrument shooting mode, and uses the imaging function of the consultee-side terminal 5 to photograph the musical instrument 2 that is the subject of consultation.

In addition, the player 3 selects a consultation matter input mode, and inputs a consultation matter relating to the photographed musical instrument 2 via an input screen for inputting consultation matters. The specific format for inputting consultation matters is not limited, and any format can be employed, such as text input, voice input, and questionnaire input (input of information by means of a questionnaire). In addition, the method, GUI, etc., by which the player 3 inputs the input information is not limited, any can be freely designed.

Alternatively, for example, the call function in the application is turned ON to set a state in which a call can be made with the support staff 4. Then, the consultation matter can be verbally conveyed to the support staff 4. In this case, the support staff 4 inputs the information on the consultation matter of the player 3 via the support-side terminal 6.

The captured image of the musical instrument 2 and information on the consultation matter are transmitted to the server device 7 via the network 8. Then, the server device 7 generates current status information relating to the current status of the musical instrument 2 and executes various support processes for resolving the consultation matter.

For example, images, text, etc., for supporting the resolution of the consultation matter are output, as support information, to the touch panel 9 of the consultee-side terminal 5 used by the player 3. It becomes possible for the player 3 to carry out operations necessary to resolve the consultation matter while checking the support information displayed on the touch panel 9.

In addition, images, text, etc., that are useful for the support work to be provided to the player 3 are displayed, as support information, on the display 10 of the support-side terminal 6 used by the support staff 4. The support staff 4 is able to provide an explanation, an instruction, etc., to the player 3 based on the support information displayed on the display 10.

There can be cases in which current status information relating to the current status of the musical instrument 2 is used as the support information output to the consultee-side terminal 5 and the support-side terminal 6. In addition, the same images, text, etc., can be output as the support information output to the consultee-side terminal 5 and the support-side terminal 6. In addition, there can be cases where sound information is generated as support information and audio output is carried out.

In addition, flexible support that can handle various consultation matters is possible, making it possible to efficiently support the resolution of consultation matters. A detailed explanation is provided below.

### Example of a Functional Configuration of the Server Device

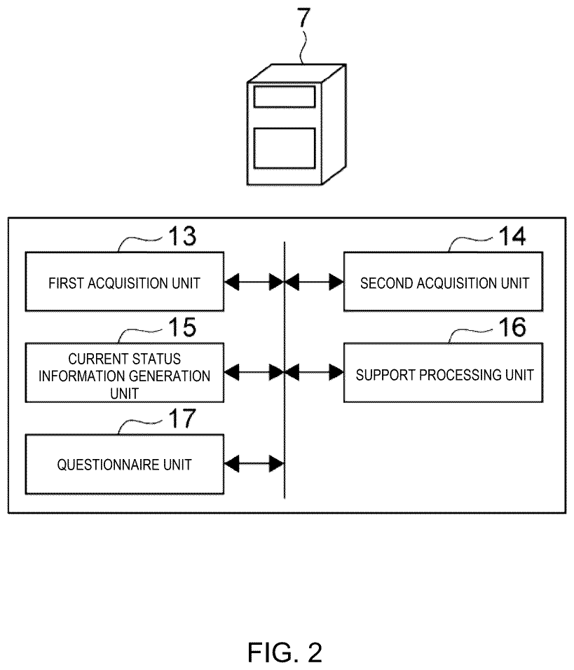

FIG. 2 is a block diagram showing a functional configuration of the server device 7. As shown in FIG. 2, in the present embodiment, the processor of the server device 7 executes a prescribed program to configure, as functional blocks, a first acquisition unit 13, a second acquisition unit 14, a current status information generation unit 15, a support processing unit 16, and a questionnaire unit 17. Of course, dedicated hardware such as an integrated circuit (IC) can be used to realize functional blocks. The processor is one example included in the electronic controller of the server device 7, and the electronic controller can be configured to comprise one or more processors. Here, the term “electronic controller” as used herein refers to hardware, and does not include a human.

The program is installed on the server device 7 via various recording media, for example. Alternatively, the program can be installed via the Internet, or the like. The type, etc., of the recording medium on which the program is recorded is not limited, and any computer-readable recording medium can be used. For example, any computer-readable, non-transitory storage medium can be used.

The first acquisition unit 13 acquires a captured image obtained by photographing the musical instrument 2. In the present embodiment, a captured image of an electronic drum set photographed by the player 3 using the consultee-side terminal 5 is transmitted to the server device 7 via the network 8.

In addition, in the present embodiment, moving images containing sound information are captured as the captured images photographed using the consultee-side terminal 5. Accordingly, if a performance image is captured by the consultee-side terminal 5, the first acquisition unit 13 can acquire information on the performance sounds of the musical instrument 2.

Information on the performance sound includes performance data in which the performance sounds of an acoustic instrument are recorded using a microphone on the consultee-side terminal 5, or the like. Not limited thereto, MIDI (registered trademark) (Musical Instrument Digital Interface) data, wireless MIDI via Bluetooth (registered trademark) or Wi-Fi (registered trademark), etc., acquired in accordance with a performance of an electronic instrument such as an electronic drum set, are also included in performance sound information.

The second acquisition unit 14 acquires information on a consultation matter relating to the photographed musical instrument 2. In the present embodiment, information is acquired on consultation matters mainly relating to the functions of the musical instrument 2. For example, information is acquired on consultation matters such as worries and concerns about the musical instrument 2 not performing the intended functions properly. Of course, the consultation matter is not limited thereto; the instrument-related support system 1 can also be applied to any consultation matter regarding the musical instrument 2.

For example, information on a consultation matter input to the consultee-side terminal 5 by the player 3 is transmitted to the server device 7 via the network 8 and acquired by the second acquisition unit 14. Alternatively, the consultation matter is verbally conveyed to the support staff 4 via the call function. The communicated consultation matter can be input to the support-side terminal 6, transmitted to the server device 7 via the network 8, and acquired by the second acquisition unit 14.

Alternatively, information on the consultation matter can be acquired by analyzing a captured image acquired by the first acquisition unit 13. For example, a state in which the appearance of the musical instrument 2 is clearly damaged can be determined by analyzing the captured image. It is also possible to estimate the damage of the musical instrument 2 as the information on the consultation matter.

In addition, a situation in which the player 3 is clearly operating the musical instrument 2 incorrectly can be determined by analyzing a captured image (particularly moving images). Information relating to an incorrect operation can also be estimated as the information on the consultation matter.

That is, the second acquisition unit 14 can acquire information on the consultation matter based on input information input by the player 3 and/or the captured image.

In the present disclosure, acquisition of information, etc., includes not only receiving the information from another device but also the device itself executing an analysis process, an extraction process, an estimation process, or the like, to generate the information. That is, both receiving information on a consultation matter and generating information on a consultation matter are included in acquiring information on the consultation matter.

The current status information generation unit 15 generates, based on a captured image of the musical instrument 2, current status information relating to the current status of the musical instrument, including information on at least one or more of the configuration of the musical instrument 2, the state of the musical instrument 2, or the installed location of the musical instrument 2.

Information relating to the configuration of the musical instrument 2 includes any information indicating how the musical instrument 2 is configured. For example, the type of the musical instrument 2, the model of the musical instrument 2, the product number of the musical instrument 2, and the year in which the musical instrument 2 was manufactured are included in information relating to the configuration of the musical instrument 2.

Information relating to the state of the musical instrument 2 includes any information indicating the state that the musical instrument 2 is in. For example, information on the setting state of the musical instrument 2 is included in information relating to the state of the musical instrument 2. In addition, when the musical instrument 2 is an electronic instrument or is used together with an electronic device, information on parameter setting states such as volume and acoustics, information on the version of the firmware of the electronic instrument and of software such as an OS (Operating System), etc., are included in information relating to the state of the musical instrument 2.

Information relating to the installed location of the musical instrument 2 includes any information indicating the location or space in which the musical instrument 2 is installed. For example, information on whether the location in which the musical instrument 2 is installed is indoors or outdoors is included. In addition, information such as whether the location in which the musical instrument 2 is installed is a live music venue, a concert hall, or a baseball stadium, is also included in information relating to the installed location of the musical instrument 2.

Note that information relating to the configuration of the musical instrument 2, information relating to the state of the musical instrument 2, and information relating to the installed location of the musical instrument 2 are not clearly distinguished and defined. One piece of information can be included in information relating to the configuration of the musical instrument 2 as well as in information relating to the state of the musical instrument 2. For example, in the musical instrument 2 that is configured by assembling a plurality of components, information relating to the state of assembly of the plurality of components is included in both information relating to the configuration of the musical instrument 2 and information relating to the state of the musical instrument 2.

For example, regarding the electronic drum set shown in FIG. 1, information relating to settings indicating how pads for the high tom, the low tom, and the floor tom, and the pads for the cymbals, etc., are arranged is included in information relating to the configuration of the electronic drum set as well as in information relating to the state (setting state) of the electronic drum set.

Of course, any information relating to the current status of the musical instrument other than information relating to the configuration of the musical instrument 2, the state of the musical instrument 2, and the installed location of the musical instrument 2, can be generated as the current status information. For example, any information relating to the current status of the musical instrument is included in the current status information, such as information relating to the current value of the musical instrument 2 (secondhand market price, etc.), information on the number of the musical instruments 2 currently in existence, and information on future production plans.

In addition, in the present embodiment, the current status information can be generated based on information on performance sounds acquired by the first acquisition unit 13. For example, information on performance sounds acquired by the first acquisition unit 13 can be used as the current status information. Alternatively, performance sound information is subjected to processing such as audio segmentation, sound source separation, and frequency analysis. The result of said processing can be used as the current status information.

Information on the consultation matter can be used for the generation of current status information. That is, the current status information can be generated based on information on the consultation matter.

The support processing unit 16 executes various support processes for supporting the resolution of consultation matters. For example, various support information for resolving a consultation matter is generated and output based on information on the consultation matter and the current status information.

Support information is information useful to the consultee-side user, such as the player 3, for the resolution of consultation matters, and includes consultee-side support information output from the consultee-side terminal 5. In addition, the support information is information useful to the support-side user when carrying out support work, and includes support-side support information output from the support-side terminal 6.

Note that consultee-side support information and support-side support information are not clearly distinguished and defined. There can be support information that is both useful to the consultee-side user and useful to the support-side user. That is, there can be support information that is both consultee-side support information and support-side support information.

In the present embodiment, a shared screen mode can be selected as an application of the instrument-related support system 1. The player 3 and the support staff 4 agree to select the shared screen mode. Then, a shared screen window is configured on the touch panel 9 of the consultee-side terminal 5 and the display 10 of the support-side terminal 6. Images, pointers, etc., displayed on the shared screen window can be viewed by both the player 3 and the support staff 4.

For example, a captured image of the musical instrument 2 photographed by the player 3 is displayed on the shared screen window. It is also possible to display, superimposed on video, various support images for resolving the consultation matter. For example, a procedure image for instructing the procedure to be taken with respect to the musical instrument 2, or a correct answer image for resolving the consultation matter is generated as a virtual image (AR image) and superimposed on the captured image captured on-site. Alternatively, a pointer image of a cursor, etc., operated by the support staff 4 is superimposed on the captured image captured on-site. Such processing is also possible.

The player 3 can carry out operations necessary for the resolution of the consultation matter while checking the shared screen window. In addition, it is possible to ask questions, etc., to the support staff 4 in real time. The support staff 4 can efficiently provide an explanation, an instruction, or the like to the player 3 while checking the shared screen window. The various support images displayed on the shared screen window are one embodiment of the support information according to the present technique.

For example, the correct state of the musical instrument 2 can be displayed as an AR display superimposed on the current state of the musical instrument 2, thereby making it possible for the player 3 to easily determine whether the current state is the correct state. In addition, it becomes easy to bring the current state of the musical instrument 2 to the correct state.

In addition, it becomes possible for both parties to use the call function and easily communicate while checking the shared screen window through exchanges like “Push this button,” “This button?”, “No, the button to the right of that button.” In addition, it becomes possible to easily provide instructions to perform, such as “Please hit the snare, bass drum, and hi-hat” to acquire information on the current performance sounds.

It is also possible to generate and output to the consultee-side terminal 5, as support information, instruction information to press a prescribed button, instruction information to play the musical instrument 2, or the like. In addition, it is possible to output to the support staff 4, as support information, an instruction to have the player 3 press a prescribed button or an instruction to have the player 3 play the musical instrument 2.

It is also possible to execute various processes as support processes, such as analysis, search, and estimation, in order to support the resolution of various consultation matters. Information and data output to the consultee-side terminal 5 and the support-side terminal 6 as a result of these support processes is included in the support information according to the present technique.

The questionnaire unit 17 outputs a questionnaire relating to the consultation matter and acquires information on the response to the questionnaire. Questionnaires related to consultation matters include a consultation matter questionnaire for inputting the consultation matter, a musical instrument current status questionnaire for generating current status information on the musical instrument 2, support questionnaire for generating support information, and the like. Of course, these various types of questionnaires are not clearly distinguished and defined. It is also possible to generate a questionnaire that functions both as the consultation matter questionnaire and the musical instrument current status questionnaire.

Typically, a questionnaire is presented to the consultee-side user. Accordingly, the questionnaire is output to the consultee-side terminal 5. For example, a consultation matter questionnaire is output in a format that assists work of the consultee-side user inputting the specific content of the consultation matter. In addition, information relating to the configuration, the state, the installed location, etc., of the musical instrument 2 that is the subject of the consultation matter is acquired as response information, and a musical instrument current status questionnaire is output in a format that assists the generation of the current status information.

In addition, the consultee-side user's knowledge regarding the musical instrument 2, information on other instruments and peripheral devices owned by the consultee-side user, information on operations that the consultee-side user can perform, etc., are acquired as response information, and a support questionnaire is output in a format that assists in supporting the resolution of the consultation matter.

Of course, a questionnaire can be output to the support-side user to acquire information on the user's knowledge regarding the musical instrument 2, other instruments and peripheral devices that can be prepared, and the like. The format for presenting various types of questionnaires is not limited, and any GUI can be configured therefor. In addition, a format other than a GUI display can be employed, such as voice input in response to a voice announcement.

By using the response information to the questionnaire, it is possible to improve the accuracy of the acquisition of information on the consultation matter, generation of current status information, and generation and output of support information. In addition, it is possible to improve the efficiency and accuracy of the support process.

Any technique (algorithm, etc.) can be used for the acquisition of information on the consultation matter, the generation of current status information, the generation of support information, and the like. For example, any machine learning algorithm using a deep neural network (DNN), a recurrent neural network (RNN), a convolutional neural network (CNN) or the like can be used. For example, artificial intelligence (AI) that carries out deep learning can be used to execute each process with high precision.

For example, a captured image of the musical instrument 2 can be input into a trained model that has undergone machine learning for outputting information on consultation matters, to thereby acquire information on the consultation matter from the trained model. In addition, a captured image of the musical instrument 2 can be input into a trained model that has undergone machine learning for generating current status information, to thereby acquire current status information from the trained model. In addition, information on the consultation matter, current status information, and the like, can be input into a trained model that has undergone machine learning for outputting support information, to thereby acquire support information from the trained model.

For example, the error backpropagation method is used as the training method for the learning model. The error backpropagation method is a commonly-used training method for training neural networks. A neural network is a model that imitates neural circuits of the human brain, and has a layered structure consisting of an input layer, an intermediate layer (hidden layer), and an output layer.

Neural networks with numerous intermediate layers are specifically referred to as deep neural networks, and the deep learning technique used for training such networks is known as a modeling approach that can learn complex patterns hidden in large amounts of data. The error backpropagation method is one such training method, and is commonly used for training CNNs used in image and video recognition.

In addition, neurochips/neuromorphic chips incorporating the neural network concept can be used as the hardware structure for realizing such machine learning.

The algorithm for training the learning model is not limited, and any machine learning algorithm can be used. Examples of machine learning algorithms include supervised learning, unsupervised learning, semi-supervised learning, reinforcement learning, inverse reinforcement learning, active learning, and transfer learning. In addition, a machine learning model such as a hidden Markov model (HMM) or a support vector machine (SVM) can be used.

A training block (training unit) for training the learning model can be configured in the consultee-side terminal 5 and the support-side terminal 6. Alternatively, the training block (training unit) can be configured in a computer different from the consultee-side terminal 5 and the support-side terminal 6, and the trained learning model after training has been executed can be installed in the consultee-side terminal 5 or the support-side terminal 6. In addition, the specific configurations of the learning model and the training block (training unit) for training the learning model are not limited.

Note that the machine learning algorithm can be applied to any process within the present disclosure. That is, a process using machine learning can be executed on any process described within the present disclosure.

In addition, the method for extracting various information from a captured image of the musical instrument 2, such as current status information and information on the consultation matter, is not limited, and any technique (algorithm) can be used. For example, any image recognition technique can be used, such as projective transformation, edge detection, and matching processing using a model image of an object. In addition, skeleton estimation (bone estimation) and similar techniques can be used. Additionally, an existing externally-constructed library having functions such as image processing and machine learning can be used.

Any machine learning algorithm can be used to extract information from captured images. For example, semantic segmentation can be executed on image information, thereby making it possible to determine the type of object for each pixel in the image.

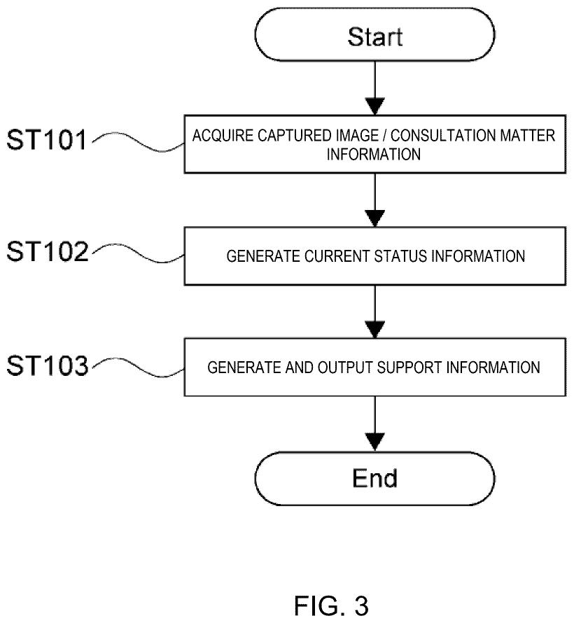

FIG. 3 is a flowchart showing an example of basic operation of the server device 7. The first acquisition unit 13 acquires a captured image obtained by photographing the musical instrument 2. In addition, the second acquisition unit 14 acquires information on a consultation matter relating to a function of the photographed musical instrument 2 (step 101).

The current status information generation unit 15 generates, based on the captured image, current status information relating to the current status of the musical instrument 2, including information on at least one or more of the configuration of the musical instrument 2, the state of the musical instrument 2, or the installed location of the musical instrument 2 (step 102).

The support processing unit 16 generates and outputs support information for resolving the consultation matter based on the information on the consultation matter and the current status information (step 103).

### Examples of Variations in Consultation Matters

Examples of information on consultation matters relating to functions of the musical instrument 2 include consultation matters relating to the configuration of the musical instrument 2, consultation matters relating to the state of the musical instrument 2, and consultation matters relating to the installed location of the musical instrument 2.

Specific examples of each of these consultation matters include the following.

Consultation matters relating to the configuration of the musical instrument 2 . . . . Do not to know how to assemble, etc.

Consultation matters relating to the state of the musical instrument 2 . . . . Do not know if the setting state is correct, want to know the correct parameter setting, want to know the correct software version, etc.

Consultation matters relating to the installed location of the musical instrument 2 . . . . Want to know the best place for installation, etc.

Other examples of information on consultation matters relating to functions of the musical instrument include consultation matters relating to a sound(s) generated by the musical instrument, consultation matters relating to a movement(s) when playing the musical instrument, consultation matters relating to a setting(s) of the musical instrument, consultation matters relating to a malfunction(s) of the musical instrument, consultation matters relating to maintenance of the musical instrument, and consultation matters relating to an expansion function(s) of the musical instrument.

Specific examples of each of these consultation matters include the following.

Consultation matters relating to a sound(s) generated by the musical instrument . . . . There is no sound, does not make the desired sound, a strange sound(s), etc.

Consultation matters relating to a movement(s) when playing the musical instrument . . . . A part of the configuration of the musical instrument moves differently than expected, a part of the configuration of the musical instrument does not move, a part of the configuration of the musical instrument is wobbly, etc.

Consultation matters relating to a setting(s) of the musical instrument . . . . Having trouble with a setting(s), want to know how to set the parameters of an electronic instrument, etc.

Consultation matters relating to a malfunction(s) of the musical instrument . . . . There is no sound (is it a malfunction?), want to dispose of a malfunctioning instrument, etc.

Consultation matters relating to maintenance of the musical instrument . . . . Want to know how to maintain the instrument, want to know a better maintenance method, etc.

Consultation matters relating to an expansion function(s) of the musical instrument . . . . Want to add on components (pads, etc.) constituting the musical instrument in an electronic drum set, etc., want to change to higher-end parts, want to expand functions in an electronic instrument, etc.

In this manner, in the instrument-related support system 1, it becomes possible to efficiently support the resolution of various consultation matters.

The various types of information described above as specific examples of consultation matters are not clearly distinguished and defined. There can be cases in which the content of a consultation matter is a consultation matter relating to the configuration of the musical instrument 2 as well as a consultation matter relating to the state of the musical instrument 2. In addition, there can be cases in which the content of a consultation matter is a consultation matter relating to sounds generated by the musical instrument as well as a consultation matter relating to a malfunction of the musical instrument.

### Support Based on Performance Sounds

In the present embodiment, the first acquisition unit 13 of the server device 7 can acquire information on the performance sounds of the musical instrument 2. Then, the current status information generation unit 15 can generate current status information based on the acquired performance sounds. In addition, the support processing unit 16 can generate support information based on the acquired performance sounds.

For example, when a consultation matter relating to the sounds generated by the musical instrument is input, generating current status information and support information based on the information on the performance sounds becomes very effective.

### Support Process Using Support History Information/FAQ Information

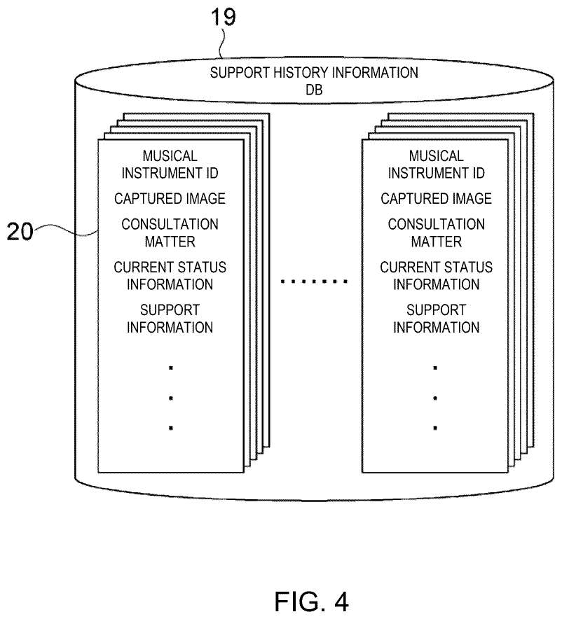

FIG. 4 is a schematic diagram showing one example of support history information 20 stored in a support history information DB 19 constructed in the DB 11. In the present embodiment, various information such as images and sounds transmitted and received in order to resolve various consultation matters are recorded and saved as video and audio recordings, etc. For example, various support images, sound information, call content, etc., displayed on a shared screen window are stored as history information.

As shown in FIG. 4, in the present embodiment, the support history information 20 includes musical instrument IDs, captured images, information on consultation matters, current status information, and support information. Information on contents of calls, etc., can also be included. These various types of information (image data and sound data) can be stored directly, or link information to each piece of information (image data and sound data) stored in another storage device, etc., can be stored as the support history information 20.

A musical instrument ID is an ID assigned in accordance with the type of the musical instrument. For example, an ID that can identify the type of the musical instrument 2 is assigned, such as acoustic drum set, electronic drum set, acoustic guitar, electric guitar, piano, etc.

For example, the type of the musical instrument 2 that is the subject of the consultation matter is determined by analyzing the captured image of the musical instrument 2, and a musical instrument ID corresponding to the type of the musical instrument 2 is assigned. Alternatively, a user of the instrument-related support system 1 such as the player 3 can input information on which type of the musical instrument the consultation matter relates to, and a musical instrument ID can be assigned based on the input information.

A captured image is a captured image of the musical instrument 2 that has been selected and photographed. It is also possible to store a plurality of captured images of one musical instrument 2 taken from different shooting locations or shooting angles with respect to the one musical instrument 2. Of course, one captured image can be selected and stored from among a plurality of captured images that have been photographed.

Current status information is current status information generated by the current status information generation unit 15. Support information is various types of support information generated and output by the support processing unit 16. A call content is the content of a call made between the player 3 and the support staff 4 via the call function.

Additionally, information input by the player 3, questionnaire information generated by the questionnaire unit 17, information on responses to questionnaires, and the like, can be stored as the support history information 20. In addition, various information (text information, call information, and the like) exchanged between the player 3 and the support staff can also be stored as the support history information 20.

The support history information 20 is information including information on consultation matters acquired in the past and support information generated and output in the past to resolve said consultation matters.

In the example shown in FIG. 4, the support history information 20 is managed for each musical instrument ID. For example, consultation matters relating to electronic drum sets input in the past by various users are assigned a musical instrument ID corresponding to electronic drum sets and are managed as the support history information 20.

As a result, it becomes possible to easily search for past support history information based on the musical instrument 2 that is the subject of the consultation matter, thereby enabling efficient support. In addition, it becomes possible to easily analyze what kind of consultation matters exist for each musical instrument 2.

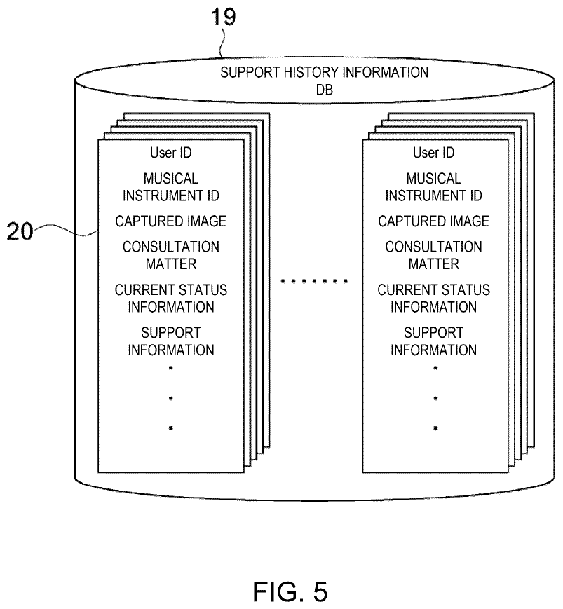

FIG. 5 is a schematic diagram showing another example of the support history information 20. In the example shown in FIG. 5, the support history information 20 is managed for each user ID assigned to consultee-side users seeking resolution of consultation matters.

For example, a user ID is assigned for each consultee-side user when creating an account for using the instrument-related support system 1. Then, consultation matters from the same consultee-side user are managed based on the user ID.

As a result, it becomes easy to analyze what kinds of consultation matters each consultee-side user has consulted about in the past, thereby realizing efficient support. For example, it becomes easy to determine whether there has been the same consultation matter in the past, making it possible to improve the efficiency of support. In addition, when information such as the area of residence is managed as user information, it becomes easy to analyze what kind of consultation matters are common for each residential area.

In addition, the support history information 20 can be managed based on the ID of the support-side user. As a result, it becomes easy to analyze what kind of consultation matters each support-side user has supported in resolving in the past, which can be used to build on the support work system in the future.

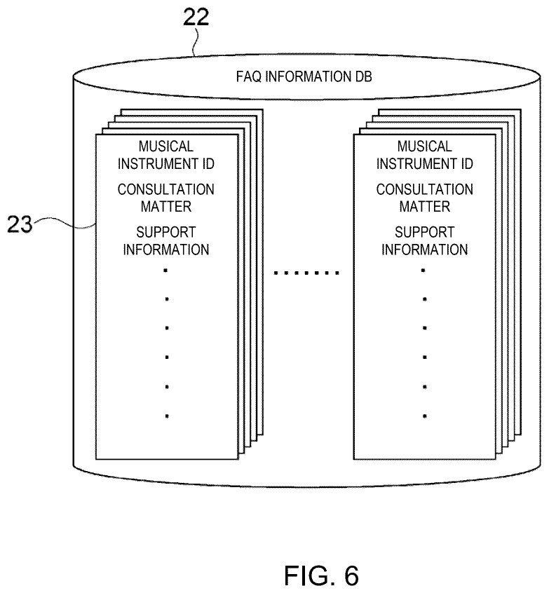

FIG. 6 is a schematic diagram showing one example of FAQ (Frequently Asked Questions) information 23 stored in a FAQ information DB 22 constructed in the DB 11. The FAQ information 23 is information containing information on consultation matters and support information created in advance, and information on consultation matters that are expected to be common consultation matters, paired with support information for resolution of said consultation matters.

As shown in FIG. 6, the FAQ information 23 is managed based on the musical instrument IDs corresponding to the types of the musical instrument 2, and stores consultation matters and support information. The FAQ information 23 is generated by, for example, analyzing the support history information 20 shown in FIGS. 4 and 5 to thereby select information on consultation matters that are frequently consulted. Appropriately managing the support history information 20 is advantageous for generating the FAQ information 23. Of course, the FAQ information 23 is not limited to being generated based on the support history information 20.

Typically, the FAQ information 23 is processed and generated from information on consultation matters that are frequently consulted so as not to contain personal information of the consultee. Information that is made public only to past support recipients can be created as a part of the FAQ information 23, in addition to information that is made public to all consultees.

In the support history information 20 shown in FIGS. 4 and 5, support information corresponding to solution actions taken by consultee-side users is stored as support information. For example, when the consultee-side user ends up going through trial and error in order to resolve a consultation matter, it is often the case that detailed support information is stored for guiding the user through the trial and error to a resolution. That is, while it is possible that the information tends to become highly individualized for each consultee-side user, there are many cases in which extremely helpful support information is stored.

On the other hand, in the FAQ information shown in FIG. 6, highly generalized (versatile) support information for guiding users to resolution of consultation matters tends to be stored as support information. That is, the support information is often simply an output of the steps to a resolution. Of course, if the consultee-side user can fully understand the support information, such simple support information if useful.

In the instrument-related support system 1, the support history information 20 stored in the support history information DB 19 can be searched, and the search result can be output, as a support processing carried out by the support processing unit 16, in response to the second acquisition unit 14 of the server device 7 acquiring information on a consultation matter.

For example, the support history information 20 corresponding to the consultation matter is searched based on a captured image of the musical instrument 2, information on the consultation matter, the current status information, and the like. Specifically, the support history information 20 of consultation matters having a content that is the same as or similar to the consultation matter is output as the search result.

Various types of information stored as the support history information 20 can be output as the search result output. Not limited thereto, of the various types of information stored as the support history information 20, it is acceptable to output only some information, such as support information.

For example, the consultee-side user can easily check support information from past consultations by other people. If the other person arrived at a resolution as a result of trial and error, it is possible to check the detailed support information leading up to the resolution, making it possible to efficiently resolve the consultation matter.

In addition, it also becomes possible for the support-side user to easily check support information that had led to a solution in the past, making it possible to use the support information as is, or further improve the support information, which can be used for supporting the consultee-side user.

In addition, the FAQ information 23 stored in the FAQ information DB 22 can be searched, and the search result can be output, as a support processing carried out by the support processing unit 16, in response to the second acquisition unit 14 of the server device 7 acquiring information on a consultation matter.

For example, the FAQ information 23 corresponding to the consultation matter is searched based on a captured image of the musical instrument 2, information on the consultation matter, the current status information, and the like. Specifically, the FAQ information 23 of a consultation matter having a content that is the same as or similar to the consultation matter is output as the search result.

Various types of information stored as the FAQ information 23 can be output as the search result. Not limited thereto, of the various types of information stored as the FAQ information 23, it is acceptable to output only some information, such as support information.

For example, the consultee-side user can easily check the FAQ information 23 corresponding to the user's own consultation matter. As a result, it is possible to efficiently resolve the consultation matter.

In addition, it also becomes possible for the support-side user to easily check support information in the FAQ information corresponding to the consultation from the consultee-side user, making it possible to use the support information as is, or further improve the support information, which can be used for supporting the consultee-side user.

Since neither the consultee-side user nor the support-side user is required to perform work such as searching for the appropriate support history information 20 or FAQ information 23 by themselves, it becomes possible to construct an efficient support system.

In addition, it becomes possible to review or reconfirm, at an appropriate timing, support information within the support history information 20 relevant to one's own consultation matter. As a result, it is possible to efficiently resolve the same consultation matters, making it possible to prevent repeated consultations. It also becomes possible to improve skills with respect to the musical instrument 2.

In addition, by providing the function to search the support history information 20 and the FAQ information 23, it becomes possible to shorten the time, reduce man-hours, and decrease the load related to the support work of the support-side user. In addition, it also becomes possible to improve the quality of the user support service.

Additionally, the feature in which the support history information 20 is accumulated over time is also advantageous for improving the efficiency in supporting the resolution of the consultation matter.

Of course, the consultee-side user and the support-side user can each carry out a search operation with respect to the support history information 20 and the FAQ information 23. For example, the support processing unit 16 can execute search of the support history information 20 and the FAQ information 23 based on an input of a search instruction from the consultee-side user and the support-side user.

### Generation of Support Images

The support processing unit 16 of the server device 7 can generate and output a support image for resolving a consultation matter. For example, various images can be displayed, such as icons, GUIs, panel images, pointer images such as cursors, text images, images of instruction manuals, and the like.

In addition, the support processing unit 16 can output a support image superimposed on a captured image of the musical instrument 2 or on a model image of the musical instrument 2.

For example, a virtual image (AR image) can be generated as a support image and superimposed on a real object of the musical instrument 2 included in a captured image. In addition, an image of the musical instrument 2 illustrated in an instruction manual for the musical instrument 2, a photograph posted on a prescribed website, an image using a 3D model data of the musical instrument 2, or the like, can be displayed as a model image, and the support image can be superimposed on said image.

In addition, a procedure image for instructing the procedure to be followed with respect to the musical instrument 2 can be displayed as a support image. For example, any form of procedure image can be adopted, such as a form in which text images with numbers indicating the procedure are displayed in sequence, a form in which pointer images are displayed in sequence at positions to be operated, or a form containing a text image explaining the procedure.

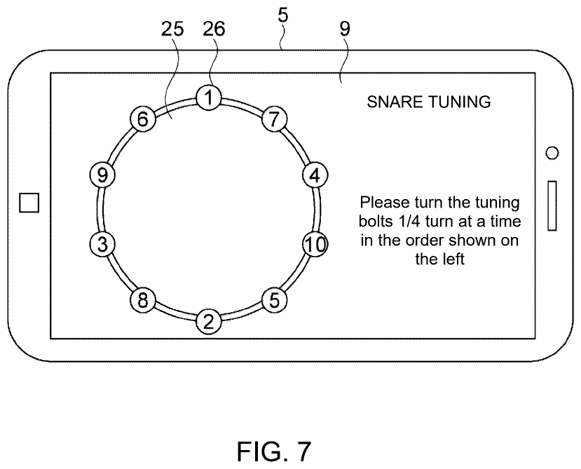

FIG. 7 is a schematic diagram showing one example of a procedure image. In the example shown in FIG. 7, a consultation matter is acquired relating to the method of tuning a snare drum 25 of an acoustic drum set. An image of the striking surface of snare drum 25 captured straight-on is transmitted as the captured image.

The support processing unit 16 displays, as a procedure image, a virtual image 26 of numbers superimposed on the real snare drum 25, and such that the numbers overlap the positions of ten tuning bolts. In addition, a text image is displayed explaining the tuning method, such as “Please turn the tuning bolts ¼ turn at a time in the order shown on the left.”

Instead of superimposing a virtual image on the real snare drum 25, the virtual image 26 of numbers can be superimposed on a model image of the snare drum 25.

For example, let us assume that imaging of the snare drum 25 is continued, and a video of the snare drum 25 is displayed on a shared screen window configured on each of the consultee-side terminal 5 and the support-side terminal 6. In this state, it is possible to display the virtual image 26 of numbers in the real-time video as the procedure image. Of course, the support staff 4 can provide support using the call function, such as stating “Please carry out tuning in the order of the numbers.”

For example, the player 3 tightens the tuning bottles in order while alternately looking at the real snare drum 25 and the virtual image 26 of numbers displayed on the shared screen window. The state of the tuning carried out by the player 3 is displayed on the shared screen window. The support staff 4 can provide support, such as “That's the correct spot,” “Please tighten the tuning bolt next to that one a little,” “That's too tight!,” etc., while checking the state of the tuning carried out by the player 3 in real time. That is, it becomes possible to provide highly accurate support efficiently.

Alternatively, there can be cases in which the support staff 4 is inexperienced and does not have much knowledge regarding tuning the snare drum 25, or the support staff 4 has forgotten how to tune the snare drum 25. Even in such cases, it is possible to efficiently support the tuning of the snare drum 25 by checking the procedure image (virtual image 26 of numbers) displayed on the shared screen window of the support-side terminal 6.

### Guide Function for Photographing the Musical Instrument

In the instrument-related support system 1, the consultee-side user who seeks a resolution of a consultation matter photographs the musical instrument 2 that is the subject of the consultation matter, and transmits the captured image. With regard to photographing the musical instrument 2, the support processing unit 16 can output shooting guide information for guiding the photography of the musical instrument 2. The shooting guide information includes, for example, information instructing at least one or more of the shooting location relative to the musical instrument 2, the shooting angle relative to the musical instrument 2, or the number of photographs to be taken of the musical instrument 2. If the consultee-side terminal 5 is equipped with a plurality of cameras (zoom/wide-angle/selfie, etc.), information instructing the appropriate camera can be output as the shooting guide information.

As long as it is possible to guide the shooting location, the shooting angle, and the number of photographs, etc., to be taken of the musical instrument 2, the specific form of the shooting guide information is not limited. For example, text images and sound information such as “Please photograph the entire drum set from the front,” “Please photograph the sound source module of the electronic drum set from the front,” and “Please photograph from the front, from above, and from the back in that order” can be output as the shooting guide information. Alternatively, an image in which the part to be photographed is displayed as a virtual image can be output as the shooting guide information.

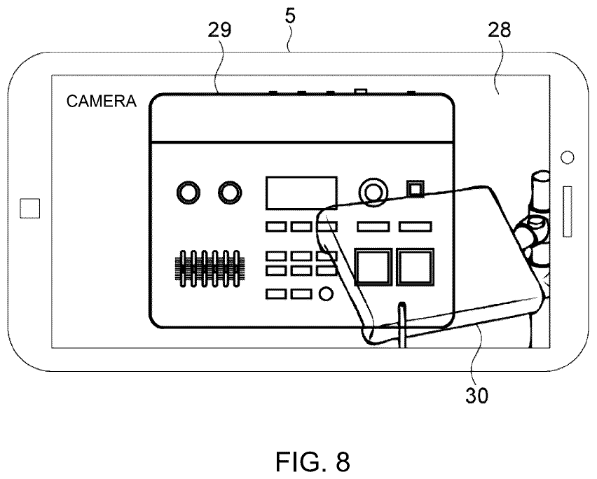

FIG. 8 is a schematic diagram showing one example of shooting guide information. In the example shown in FIG. 8, a virtual image 29 indicating a sound source module of an electronic drum set is displayed as the shooting guide information on a camera screen 28, when an instrument photographing mode is selected. The virtual image 29 is displayed so as to be superimposed on a real object 30 (real object 30 included in the angle of view), such as a sound source module to be photographed. Furthermore, text images and sound information such as “Please photograph your sound source module by matching with the sound source module displayed in the center of the screen” can be output as the shooting guide information.

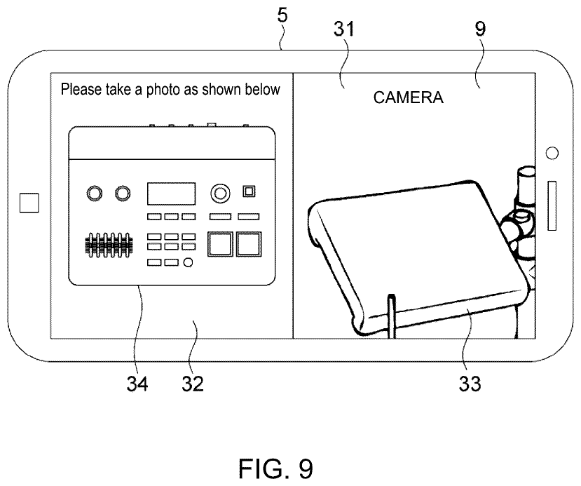

FIG. 9 is a schematic diagram showing another example of the shooting guide information. In the example shown in FIG. 9, the display area of the touch panel 9 is split into left and right halves, configuring a camera screen 31 for capturing an image and a reference screen 32. A real object 33 included in the angle of view is displayed on the camera screen 31. The reference screen 32 shows a reference image 34 indicating an example of a captured image that is effective in supporting the resolution of the consultation matter. In addition, the reference screen 32 displays a text image stating “Please photograph your sound source module in the same way as the sound source module that is displayed” (another wording is used in FIG. 9). In this manner, the reference image 34 and text images can be displayed as shooting guide information. Of course, sound information can also be used.

It becomes possible for the player 3 to use the shooting guide information and efficiently photograph a captured image that is effective in supporting the resolution of the consultation matter. As a result, efficient support is realized.

The support processing unit 16 can automatically set optimal imaging conditions. For example, optimal conditions for the shooting location and the shooting angle relative to the musical instrument 2, and number of photographs, etc., to be taken of the musical instrument 2 can be automatically set. In addition, if the consultee-side terminal 5 is equipped with a plurality of cameras (zoom/wide-angle/selfie, etc.), the optimal camera can be automatically selected. As a result, the player 3 can efficiently photograph a captured image that is effective in supporting the resolution of the consultation matter. As a result, efficient support is realized.

### Link Information Output

The support processing unit 16 can also output, as support information, link information (for example, a URL (Uniform Resource Locator)) of a web page (website) for resolving the consultation matter. The link information is effective for resolving the consultation matter. In addition, it is also possible to output link information (for example, information on telephone numbers and links to web pages) for facilities and stores that are useful for resolving the consultation matter.

### SPECIFIC OPERATION EXAMPLES

Specific operation examples will be described with respect to support for resolution of consultation matters using the instrument-related support system 1.

### Operation Example 1: Consultation Matter Relating to Sounds Generated by the Musical Instrument

Content of the consultation matter: the sound of the electric guitar is not the same as the CD source. Compared to the ideal CD source sound, the sound is flimsy.

Effective captured image: video of the electric guitar being played, video of the amplifier to which the electric guitar is connected, and peripheral devices such as effectors connected to the electric guitar. These videos contain sound information, and also performance sounds of the electric guitar.

Input information input by the player 3: information on the ideal musical piece (CD title, song name, link information, feature information on the song, etc.)

Current status information generated by the current status information generation unit 15: information relating to the configuration of the electric guitar, such as the type, model, and product number of the electric guitar. Information relating to the state of the electric guitar, such as positions of the control knobs of the electric guitar, and whether a capo is attached. Information relating to the configuration of peripheral devices, such as types and product numbers of peripheral devices such as amplifiers and effectors. Information relating to the states of peripheral devices, such as the positions of the control knobs of amplifiers and effectors. In the present disclosure, current status information relating to peripheral devices are included in the current status information of musical instruments.

Furthermore, information on the performance sounds of the electric guitar are acquired as current status information.

Support process executed by the support processing unit 16: it is possible to execute a process of comparing the current performance sound of an electric guitar with the ideal sound. For example, frequency analysis is executed on both pieces of sound information, and the analysis results are compared. In addition, any information useful for bringing the current performance sound of the electric guitar to the ideal sound is detected. These comparison results and analysis results are included in the support information.

There can be cases in which the performance sounds acquired by playing the musical instrument 2 include sounds other than the sounds intentionally output by the player 3. For example, in an acoustic instrument (such as an acoustic guitar), not only the sound produced by plucking the strings, but also the sound of fingers rubbing against the strings during position changes such as chord changes can be included. In addition, there can be cases in which noise generated when fingers accidentally hit the body is included.

In addition, for example, when a player is wearing headphones while playing an electronic instrument (for example, an electronic keyboard instrument), there can be cases in which performance sounds heard through the headphones, and mechanical sounds of pressing the key of the keyboard heard by people other than the player 3, are both included.

In addition, when playing a guitar, or the like, there are cases in which the player 3 taps their feet to keep rhythm, in which case the feet tapping sound can be included in the performance sounds. Additionally, when amplifiers and speakers are used as peripheral devices, there can be cases in which buzzing noise (rattling sound) of the amplifiers and speakers are included in the performance sounds.

In this manner, performance sounds include true performance sounds of the musical instrument 2 intentionally output by the player 3 and other sounds that are generated in conjunction with the performance. Other sounds that are generated in conjunction with the performance include movement sounds of the player 3 (sounds caused by performance movements of the player 3), and movement sounds of the musical instrument 2 (sounds caused by the movement of the musical instrument 2 during the performance).

For example, the above-mentioned sounds of plucking the strings of an acoustic guitar and sounds heard through headphones of an electronic keyboard instrument, etc., are included in the true performance sounds. Movement sounds of the player 3 include the sound of fingers rubbing against the strings of an acoustic guitar, etc., noise generated due to incorrect finger movements, and the sound of tapping the feet of the player 3. Operation sounds of the musical instrument 2 include the sound of pressing the keys of an electronic keyboard instrument, etc., and buzzing noise (rattling sound) of speakers, etc.

In the instrument-related support system 1, various sounds contained in the performance sounds can be extracted and separated as appropriate and used for the support process. For example, the current status information generation unit 15 can execute a process for extracting/separating the true performance sounds, movement sounds of the player 3, and operation sounds of the musical instrument 2, from the performance sound information acquired by the first acquisition unit 13, and the result of the processing can be generated as current status information. Alternatively, sounds that are estimated to be effective (important) for the resolution of the consultation matter can be extracted and separated.

In addition, the support processing unit 16 can execute a process for extracting/separating the true performance sounds, movement sounds of the player 3, and operation sounds of the musical instrument 2, from the performance sound information. Of course, sounds that are estimated to be effective (important) for the resolution of the consultation matter can be extracted and separated.

For example, in the present (operation example 1), true performance sounds are extracted and separated as sounds estimated to be effective (important) for the resolution of the consultation matter. The sounds are used by the support processing unit 16 for the support process, such as the comparison process described above. It is thereby possible achieve support with even higher accuracy.

In this manner, by the current status information generation unit 15 and the support processing unit 16 executing a process to extract/separate various sounds contained in the performance sounds, it become possible to achieve highly-accurate support.

It is also possible, as a support process, to detect information on equipment necessary for creating a sound that is closer to the ideal sound. For example, information on strings, picks, amplifiers, effectors, etc., that is useful for bringing the sound closer to the ideal sound is generated as support information. It is also possible to generate support information that assumes using the current amplifiers and effectors, etc. For example, information on control knob settings of the amplifier and the effectors that is useful for bringing the sound closer to the ideal sound can be generated and output as support information.

It is also possible to generate and output, as support information, link information to a know-how site (web page) that contains detailed information on electric guitar sound creation. It is also possible to generate and output, as support information, link information to a web page for purchasing useful peripheral devices.

It is also possible to generate and output a procedure image for realizing ideal sound creation as support information. For example, it is possible to generate and output, as support information, a procedure image that provides guidance on the ideal settings of the control knobs of the electric guitar, the amplifier, and the effectors that are visible in the captured image photographed by the player 3. For example, a virtual image can be generated as a procedure image and superimposed on the captured image.

Of course, various support processes described above can also be executed with respect to the consultation matter, such as searching the support history information 20 and searching the FAQ information 23. The foregoing also applies to the operation examples described below.

### Operation Example 2: Consultation Matter Relating to Sounds Generated by the Musical Instrument

Content of the consultation matter: the sound of the recorder is strange. In particular, the F note in particular does not come out well.

Effective captured image: video of the recorder. Video of the recorder being played (including information on the blown sound). In particular, video when the F note is being played. A video of the recorder being held in the hand (not being played). In particular, a video of how the recorder is being held when producing the F note.

Current status information generated by the current status information generation unit 15: information relating to the configuration of the recorder, such as the model name of the recorder and whether the recorder is a German-style recorder or a Baroque-style recorder. Information relating to the state of the recorder, such as the assembled state of the recorder. Information on the performance sounds of the recorder (in particular, information on the F note).

Support process executed by the support processing unit 16: it is possible to execute a process of comparing how the recorder is held (finger positioning) in the captured image and the correct way of holding (finger positioning) for both German-style and Baroque-style recorders. For example, an image analysis technique is used to determine whether the player 3 is holding the recorder correctly in accordance with the type of the recorder. The determination result is included in the support information.

It is also possible, as a support process, to determine whether the recorder is correctly assembled. For example, an image processing technique can be used to execute a process to compare with the correct assembled state, to thereby determine whether the recorder is in the correct assembled state or determine whether there are any irregularities in the assembly. The determination result is included in the support information. If the assembled state is incorrect and there are gaps between the head joint, middle joint, and foot joint, the pitch of the blown sound will change. Accordingly, determining the assembled state is very effective.

It is also possible to generate and output, as support information, information indicating whether the recorder of the player 3 is a German-style recorder or a Baroque-style recorder. It is also possible to generate and output, as support information, information indicating the correct way of holding (finger positioning) each type.

In addition, it is possible to generate and output, as support information, link information to a know-how site (web page) that contains detailed information on the holding method (finger positioning) in accordance with the type of recorder. It is also possible to generate and output, as support information, link information to a web page for purchasing instruction books for recorders.

It is also possible, as a support process, to determine whether the recorder is malfunctioning. The determination result is included in the support information. If the recorder is malfunctioning, information to convey that point can also be generated and output as support information.

### Operation Example 3: Consultation Matter Relating to Sounds Generated by the Musical Instrument

Content of the consultation matter: the electronic drum set does not produce a sound (no sound).

Effective captured image: video of the electronic drum set being played (including MIDI data). Video of the sound source module in operation (including MIDI data). Video including the connection state of various cables (including connections of outlets).

Current status information generated by the current status information generation unit 15: information relating to the configuration of the electronic drum set, such as the type, model, and product number of the electronic drum set. Information relating to the state of the electronic drum set, such as the settings of the pads and sound source modules of the electronic drum set. Information relating to the state of the electronic drum set, such as the positions of the control knobs and of an equalizer of the sound source module.

Support process executed by the support processing unit 16: it is possible to determine the presence/absence of an abnormality in the cable connection state, to suggest the possibility that the connection cable can be unplugged, to determine whether the volume is set correctly, to determine whether there is an unintended connection to the earphone jack, etc.

In addition, it is also possible to generate and output, as support information, information prompting the user to check whether the connection state is correct. For example, it is possible to generate and output information prompting confirmation such as “Is the power outlet plugged in?” “Is the cable correctly connected?” “Is the volume set correctly and as intended?” and “Is there anything plugged in the earphone jack?”

Of course, information instructing the correct setting, warning information, and the like, can be output based on the determination results described above. For example, information such as “The power outlet is not plugged in, please connect” “The volume is very low” “Please unplug the earphones from the earphone jack” can be generated and output as support information.

It is also possible, as a support process, to generate and output a support image indicating cables that are likely to be the cause of the problem. It is also possible to generate and output a support image showing the correct connection state. Additionally, it is possible to generate and output a procedure image showing the setting procedure for the volume, etc. These support images (procedure images) can be generated as virtual images and superimposed on a real object in the captured image.

### Operation Example 4: Consultation Matter Relating to Expansion Functions of the Musical Instrument

Content of the consultation matter: Not sure if pads can be added to the electronic drum set. Not sure which models of pads are guaranteed to work.

Effective captured image: video of the entire electronic drum set. Video of the sound source module in operation (including MIDI data). Video including the connection state of various cables (including connections of outlets).

Input information input by the player 3: information on the pad to be added (model name, etc.). If an image of the pad to be added can be acquired, such an image can be input as image information.

Current status information generated by the current status information generation unit 15: information relating to the configuration of the electronic drum set, such as the type, model, and product number of the electronic drum set. Information relating to the configuration of the sound source module, such as the type, model, and product number of the sound source module. Information relating to the configuration of the sound source module is included in information relating to the configuration of the musical instrument.

Support process executed by the support processing unit 16: it is possible to determine whether a pad can be added. In addition, it is possible to detect and output information on pads that are guaranteed to work with the sound source module. For example, it is possible to query a database that stores information on pads that have been confirmed to work with the sound source module, extract information relating to whether the pad to be added can be used or restrictions when used, and output the information as support information.

It is also possible, as a support process, to present information (catalog information, detailed information, etc.) of pads that can be added to the sound source module being used. It is also possible to generate and output, as support information, link information to a web page in which sound source modules are associated with pads that can be used therewith, and link information to web pages for purchasing pads that can be added.

### Operation Example 5: Consultation Matter Relating to Sounds Generated by the Musical Instrument

Content of the consultation matter: the sound of the electronic keyboard instrument is strange. The sound when pressing a key is strange.

Effective captured image: video of a performance (including performance sounds). Video including movements of the keys (including performance sounds). Video of the behavior of the electronic keyboard instrument when an operation to change the timbre is carried out (including performance sounds).

Current status information generated by the current status information generation unit 15: information relating to the configuration of the musical instrument, such as the type, model, and product number of the electronic keyboard instrument. Information on the performance sounds of the electronic keyboard instrument. Information on the performance sounds when an operation to change the timbre is carried out.

It is also possible for the current status information generation unit 15 to output an instruction relating to an operation to change the timbre. The player 3 operates control knobs, etc., of the electronic keyboard instrument to change the timbre in accordance with an instruction to change the timbre output via the consultee-side terminal 5, and captures video of the electronic keyboard instrument during that time. An instruction to change the timbre, etc., can be executed by the support processing unit 16.

Support process executed by the support processing unit 16: it is possible to execute a process of comparing the performance sound after the timbre change operation and the proper sound information expected from the change operation. It is also possible to estimate the cause of an abnormal performance sound after a change operation. For example, information such as whether the abnormal timbre is caused by a malfunction or caused by a setting error of the parameters, etc., can be estimated as cause information. The estimated cause information is included in the support information. By estimating the cause in this manner, it becomes possible to distinguish between a specification of the electronic keyboard instrument and a malfunction or a setting error.

It is also possible, as a support process, to generate and output support information corresponding to he estimated cause. For example, in the case of a specification of the electronic instrument, it is possible to generate and output information asking a question such as “This is as per the specifications, what would you like to do?”

In the case of a malfunction, for example, it is possible, as a support process, to present places to request a repair, to generate and output link information on places to request a repair (for example, information on telephone numbers and web page links), to present an estimated repair cost, to instruct temporary measures (for example, instructing to refrain from using the musical instrument), and the like.

In the case of a setting error, it is possible to generate and output, as support information, link information to a web page containing detailed information on parameter settings of the electronic keyboard instrument, for example. It is also possible to generate and output a procedure image for correcting the settings. For example, a virtual image can be generated as a procedure image and superimposed on the captured image.

### Operation Example 6: Consultation Matter Relating to Movements During Performance of the Musical Instrument

Content of the consultation matter: the movements of the keys of the electronic keyboard instrument is strange (poor return). Effective captured image: video of a performance (including performance sounds). Video including movements of the musical instrument (including performance sounds). Video including movements of the keys (including performance sounds).

Current status information generated by the current status information generation unit 15: information relating to the configuration of the musical instrument, such as the type, model, and product number of the electronic keyboard instrument. Information on the performance sounds of the electronic keyboard instrument.

Support process executed by the support processing unit 16: it is possible to determine whether the electronic keyboard instrument is malfunctioning. In the case of a malfunction, it is also possible to estimate the cause of the malfunction. For example, it is possible to estimate the cause of the malfunction, such as whether it is a mechanical failure caused by age deterioration, or whether it is caused by intrusion of foreign matter, such as a paperclip, etc., falling in a gap between the keys.

It is possible for the current status information generation unit 15 or the support processing unit 16 to extract/separate the sounds of key depressions as sounds that are estimated as being effective (important) for the resolution of the consultation matter. By using the sounds of key depressions, it becomes possible achieve support with even higher accuracy.

It is also possible, as a support process, to present places to request a repair, to generate and output link information on places to request a repair (for example, information on telephone numbers and web page links), to present an estimated repair cost, to instruct temporary measures (for example, instructing to refrain from using the musical instrument), and the like.

### Operation Example 7: Consultation Matter Relating to Maintenance of the Musical Instrument

Content of the consultation matter: want to know how to maintain the musical instrument.

Effective captured image: video of the musical instrument.

Current status information generated by the current status information generation unit 15: information relating to the configuration of the musical instrument, such as the type, model, and product number of the musical instrument. Information relating to the state of the musical instrument.

Support process executed by the support processing unit 16: it is possible to search for FAQ information relating to maintenance of the musical instrument. It is also possible to generate and output, as support information, link information to a web page containing detailed information regarding maintenance of the musical instrument, and link information to web pages for purchasing musical instrument maintenance products.

It is also possible to generate and output a procedure image indicating maintenance procedures. For example, a procedure image indicating maintenance procedures can be superimposed on the musical instrument visible in the captured image taken by the player 3.

### Operation Example 8: Consultation Matter Relating to Malfunction of the Musical Instrument

Content of the consultation matter: want to dispose of a malfunctioning musical instrument.

Effective captured image: video of the musical instrument. Video including peripheral devices of the musical instrument. Video of the musical instrument being moved, if the musical instrument is movable.

Input information input by the player 3: detailed information on the disposal method (is the desire to dispose? Or to sell? etc.).

Current status information generated by the current status information generation unit 15: information relating to the configuration of the musical instrument, such as the type, model, and product number of the musical instrument, the size and weight of the musical instrument, etc. Information relating to the state of the musical instrument, such as the degree of the malfunction. Information relating to the installed location of the musical instrument, such as where the musical instrument is installed. It is also possible to generate, as current status information, information on whether the musical instrument comes with a disposal pickup service, or whether the model is subject to a recall.

Support process executed by the support processing unit 16: In the case of a musical instrument that comes with a disposal pickup service, it is possible to generate and output, as support information, link information for a disposal pickup service (for example, information on telephone numbers and links to web pages). It is also possible to generate and output link information to waste collection companies (for example, information on telephone numbers and links to web pages). In the case of a model subject to a recall, it is also possible to generate and output link information to a designated support center (for example, information on telephone numbers and links to web pages).

It is also possible to support the resolution of consultation matters relating to disposal of musical instrument, regardless of whether the musical instrument is malfunctioning.

### Operation Example 9: Consultation Matter Relating to Learning the Musical Instrument

Content of the consultation matter: want to join a music school.

Effective captured image: video of the musical instrument.

Input information input by the player 3: profile of the consultee. Information relating to the format of lessons the consultee would like to receive.

Current status information generated by the current status information generation unit 15: information relating to the configuration of the musical instrument, such as the type, model, and product number of the musical instrument. The age group and residential area of the consultee.

Support process executed by the support processing unit 16: it is possible to search for music schools corresponding to the musical instrument that the consultee wishes to learn and the consultee-side user's age group and residential area. It is also possible to generate and output, as support information, link information to music schools (for example, information on telephone numbers and links to web pages). It is also possible to introduce online lessons and educational apps, as well as to generate and output link information to web pages for taking online lessons.

### Generating Progress Information

The support processing unit 16 can also generate progress information relating to the progress of the support for resolving the consultation matter. For example, it can be determined from the communication, etc., between the player 3 and the support staff 4 using the shared screen window whether the consultation matter is progressing smoothly toward a resolution, whether the situation is stagnated, or whether the situation is deteriorating, and the result can be generated as progress information.

In addition, the operations leading up to a resolution can be divided into stages (steps), and information on the current step, etc., can be generated as progress information. For example, the progress can be divided into stages, such as cause identification step, first solution step, second solution step, and solution completion step.

In addition, time taken to identify the cause (time taken for the cause identification step), the time taken for each step, and the like, can be generated as progress information. As a result, it becomes possible to analyze steps that are easy for the consultee-side users to clear and steps that are difficult for consultee-side users, which can be used for more efficient support in the future.

In addition, it also becomes possible to analyze steps that are easy to support and steps that are difficult to support for the support-side users, which can be used for more efficient support in the future. In addition, it becomes possible for the support-side user to analyze steps that the user is, and is not, good at handling, which allows for efficient reassignment of support staff, etc.

The generation of the progress information can be automatically executed using machine learning by the support processing unit 16 of the server device 7. Not limited thereto, the progress information can be generated in accordance with input of progress confirmation, etc., by a support-side user, such as the support staff. In the instrument-related support system 1, for example, efficient support using a shared screen window is possible, so it is possible to easily confirm the progress up to the resolution of the consultation matter, and to generate highly accurate progress information.

In the present embodiment, the instrument-related support system corresponds to one embodiment of the information processing system according to this disclosure. The server device 7 corresponds to one embodiment of the information processing device according to this disclosure.

As described above, in the instrument-related support system 1 according to the present embodiment, a captured image obtained by photographing the musical instrument 2 and information on the consultation matter relating to the musical instrument 2 are acquired. In addition, current status information relating to the current status of the musical instrument is generated based on a captured image of the musical instrument. Support information for resolving the consultation matter is generated and output based on the information on the consultation matter and the current status information. As a result, it becomes possible to efficiently support the resolution of the consultation matter relating to the musical instrument. In particular, in the embodiment described above, information is acquired on a consultation matter relating to a function of the musical instrument 2, and the instrument-related support system 1 is able to efficiently resolve the consultation matter relating to the function of the musical instrument 2.

It becomes possible for the instrument-related support system 1 to construct a system that can efficiently and appropriately obtain, from a consultee-side user such as the player 3, information necessary for a support-side user such as the support staff 4, when providing support for the musical instrument 2 such as an electronic drum set, which reduces the burden of both the consultee-side user and the support-side user, making it possible to improve the satisfaction of the performance activities of the player 3, for example.

By implementing the present technique, it becomes possible to automatically obtain information on the product number, installation status, and sounds from a video of the actual musical instrument when providing support for problems that arise when the player 3 plays the musical instrument 2, and to convey information required for support to the support-side user efficiently and with high accuracy.

In addition, by implementing the present technique, it becomes possible to display, on a screen, instructions, etc., from the support-side user and to send, to the support-side user, a video of operations performed by the consultee-side user to resolve the problem, thereby making it possible to sufficiently prevent procedural errors and enable the user to smoothly return to performance activities.

Additionally, by implementing the present technique, it becomes possible to reduce “unnecessary additional knowledge” and “stress caused by contacting” when the consultee-side user such as the player 3 receives support, thereby making it possible to provide the value of allowing the user to focus more on the act of playing the musical instrument.

For example, when feeling confused or troubled while playing a musical instrument, there are many cases in which the problem cannot be solved on one's own. When one contacts support, support will ask for detailed information about the current status, and in most cases, information exchange takes place over the phone or text-based communication. Therefore, it takes time and effort to understand the current status. Furthermore, in order to implement measures instructed by the support team on one's own and returning to a good status requires more time and effort.

There can be players 3 for whom such burden becomes tiresome, and who will continue to use the instrument without contacting support, or even distance themselves from playing the musical instrument. It is likely that many of these players (3) feel they “should be able to focus only on playing” and that “learning troubleshooting methods is extra work they should not have to do.”

On the other hand, musical instruments 2 can be used in a variety of places and for a variety of purposes, and the possibility of a malfunction is not zero, so it is difficult to provide, as a product, a versatile instrument that is free of problems, or to make the musical instrument itself capable of dealing with problems 100% of the time. That is, it is indeed necessary for consultee-side users such as the player 3 to have access to support

By constructing the instrument-related support system 1, it becomes possible to sufficiently reduce the burden of receiving support and burden of resolving the consultation matter for the consultee-side user, who is the customer, thus realizing efficient support.

In addition, it is also possible to construct the instrument-related support system 1 with support-side users positioned as intermediate customers. It becomes possible for the instrument-related support system 1 “to provide information required for work, in the necessary form” to the support-side user who carries out support work, thereby providing value such as reducing the workload and allowing smoother arrival at resolutions of consultation matters.

For example, when helping a consultee-side user faced with a problem playing a musical instrument, etc., the on-site situation can vary widely. Therefore, at the beginning of support work, it is extremely important to research the current status of the consultee-side user, but the consultee-side user cannot necessarily answer smoothly all of the “information necessary for support work”.

For example, questions such as: what is the model name and the kit name of your electronic drum set? Is the firmware the latest version? How long did you play? and What is the version of the smartphone OS you are using in combination? cannot be immediately answerable. Even with other instruments, many people would not know the answer to a question like “What year model is it?”

It is difficult to smoothly obtain the above-mentioned information only through talking on the phone or via Email messages. On the other hand, if such information can be smoothly conveyed to the support-side user in the initial stages of contact with the support-side user, more efficient support becomes possible by linking the information with know-how (FAQ information, etc.), such as “common problems for each model,” for example.

In addition, it can be expected that it would be stressful for both the support-side user and the consultee-side user if the transmission of information turns into repeated rounds of questions. On the other hand, if information transmission becomes smooth, it would lead to a sense of comfort that “of course someone from the manufacturer would know best” and “it's pleasant that they don't ask unnecessary questions,” which leads to high added value.

By constructing the instrument-related support system 1, it becomes possible to efficiently let the support-side user understand information necessary for support that the consultee-side user cannot immediately answer, or requires time or causes stress for the consultee-side user to research on their own. In addition, it becomes possible to efficiently convey, to the consultee-side user, information such as an instruction from the support-side user. As a result, it becomes possible to efficiently support the resolution of the consultation matter.

### Second Embodiment

An instrument-related support system of a second embodiment according to this disclosure will be described. Hereinbelow, descriptions of parts having the same configurations and effects as those of the instrument-related support system 1 described in the above-mentioned embodiment will be omitted or simplified.

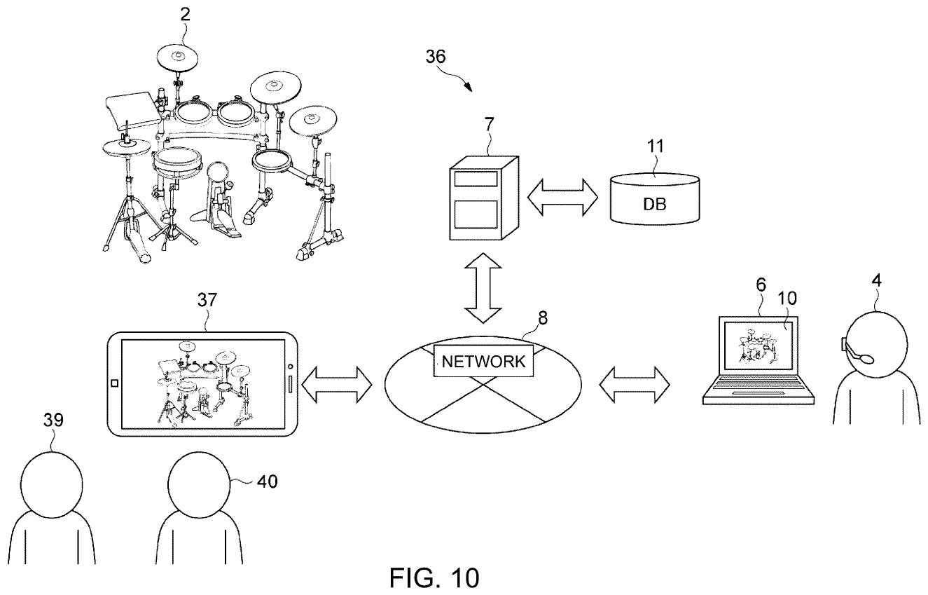

FIG. 10 is a schematic diagram showing a configuration example of an instrument-related support system according to the second embodiment. An instrument-related support system 36 shown in FIG. 10 uses an on-site support-side terminal 37 instead of the consultee-side terminal 5 shown in FIG. 1.

The on-site support-side terminal 37 is a terminal used by a support-side user (hereinafter referred to as on-site support-side user) 40 who meets on-site with a consultee-side user 39 such as the player 3 shown in FIG. 1 and responds to a consultation from the consultee-side user 39.

In the example shown in FIG. 10, a smartphone is used as the on-site support-side terminal 37, but no limitation is imposed thereby; any computer having an imaging function can be used. In addition, a call function is provided to each of the on-site support-side terminal 37 and the support-side terminal 6, allowing calls to be placed between the on-site support-side user 40, and the support staff 4 who is positioned as another support-side user.

Examples of on-site support-side users 40 include on-site staff of an instrument manufacturer, etc., a music teacher at a school, a teacher at a music school, a salesclerk at a music store, and the like.

For example, a terminal having the same functions as the consultee-side terminal 5 described in the first embodiment can be used as the on-site support-side terminal 37. Let us assume that the on-site support-side user 40 has received sufficient training regarding the method of use of the on-site support-side terminal 37. In this case, compared to a case in which the consultee-side user 39 uses the consultee-side terminal 5, it becomes possible to more efficiently carry out operations such as photographing the necessary captured image of the musical instrument 2, inputting the necessary information, the method of using the shared screen window, and the like. As a result, it becomes possible to efficiently support the resolution of the consultation matter.

Of course, the functions, etc., of the on-site support-side terminal 37 can be configured to be different from the consultee-side terminal 5, in a manner that is specialized as a terminal for on-site support-side users 40. For example, compared to the consultee-side terminal 5, operation methods that are based on more specialized knowledge can be output, or support using more technical terms can be provided.

For example, let us assume that support staff with extremely deep knowledge and who is experienced in support work responds to a consultation matter on-site. In this case, isolating the problem and understanding the necessary measures, the current status, and identifying the cause often proceed smoothly. For example, it is possible that, after isolating the problem, the staff communicates with the support staff 4 over the phone or searches the web using the staff's own terminal, and adequately handles the problem. Of course, it is possible to use the instrument-related support system 1 further to improve efficiency of support.

There also can be cases where someone with little knowledge and experience is in charge as the on-site support-side user 40. In this case, there can be cases in which isolating the problem or understanding the current status is difficult, and exchanging information with the support staff 4 does not go smoothly. In such a case, the consultee-side user 39 will feel disappointed on-site.

In the instrument-related support system 36, it becomes possible to efficiently support the resolution of various consultation matters by the on-site support-side user 40 who uses the on-site support-side terminal 37.

For example, the on-site support-side terminal 37 can output current status information and support information that can be ascertained from the appearance of the product, such as “type of musical instrument,” “manufacturer, model number,” “installation location,” and “degree of malfunction as revealed by appearance.” In addition, it becomes possible for the on-site support-side terminal 37 to output search results of support history information and FAQ information.

Additionally, if it is necessary to obtain instructions from highly-specialized staff, it is also possible to construct a shared screen window with the support-side terminal 6 that is installed remotely and display the necessary procedures, operation guides, etc. It becomes possible to exchange visual and instinctive questions and instructions via the shared screen window, and to eliminate communication that frequently uses vague demonstrative pronouns such as “that” and “this.” In addition, because the support staff 4 can also see the measures taken by the on-site support-side user 40, it becomes possible to check whether instructions have been properly conveyed.

There can be situations in which it is absolutely necessary to send a specialist on-site. Even in such cases, because it is possible to efficiently convey to the specialist initial information, etc., using the on-site support-side terminal 37, it is possible to avoid repeating the same diagnostic questions. Of course, if a specialist uses a support-side terminal, it is possible to ascertain the initial information, etc., before arriving on-site. These effects also apply to the first embodiment.

As described above, the instrument-related support system 36 according to the present embodiment also makes is possible to efficiently support the resolution of consultation matters. The on-site support-side terminal 37 can also be referred to as “instrument recognition and guide terminal” or “instruction terminal.”

### Third Embodiment

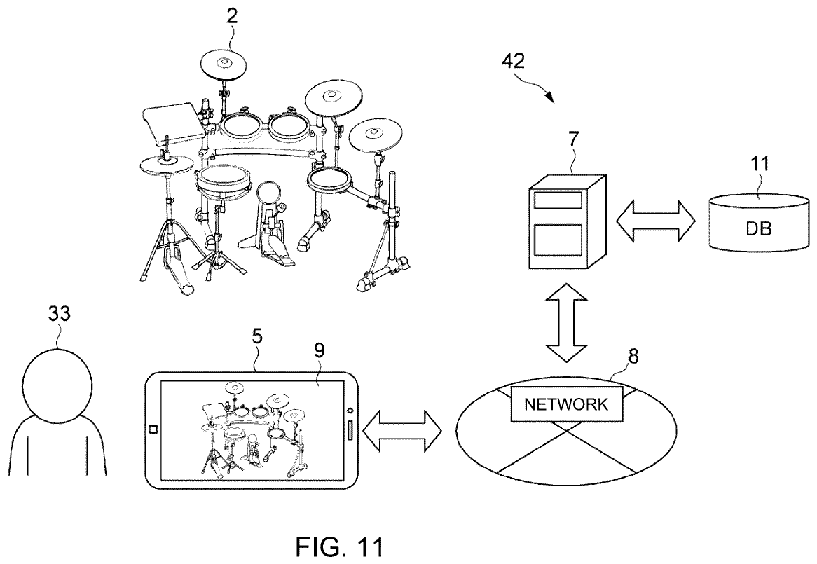

FIG. 11 is a schematic diagram showing a configuration example of an instrument-related support system according to a third embodiment. An instrument-related support system 42 shown in FIG. 11 is not provided with the support-side terminal 6 shown in FIG. 1. That is, the instrument-related support system 42 shown in FIG. 11 is configured such that support service is not provided by the support staff 4 who can respond remotely.

In the instrument-related support system 42 shown in FIG. 11, automatic support is provided by the server device 7. For example, various service processes using machine learning, etc., and output of various service information are automatically executed. Of course, it is also possible to output, etc., search results of support history information and FAQ information.

The consultee-side user 39 can input consultation matters 24 hours a day without worrying about the time, thereby achieving high usability. In addition, even someone who is not comfortable speaking with another person on the phone can use the instrument-related support system 42 without hesitation.

Note that the instrument-related support system 42 shown in FIG. 11 can also be regarded as a configuration of the instrument-related support system 1 shown in FIG. 1 for use outside business hours of customer service, when remote support from the support staff 4 is unavailable.

From such a viewpoint, the instrument-related support system 1 shown in FIG. 1 can be regarded as a useful system that can provide efficient support even outside of business hours of customer service.

The consultee-side user 39 can be able to switch the call mode with the support staff 4 ON and OFF. For example, the user turns the call mode with the support staff 4 OFF at first and receives automated support in the form of the instrument-related support system 42 shown in FIG. 11. Then, when it appears as if the consultation matter would not be resolved or when more knowledge is desired, the user turns the call mode with the support staff 4 ON, and receives support in the form of the instrument-related support system 1 shown in FIG. 1. Such an operation can be possible.

A configuration can be employed in which the support-side terminal 6 is not provided in the instrument-related support system 36 shown in FIG. 10. That is, a configuration can be employed in which support service is not carried out by the support staff 4 who can respond remotely. Of course, the system configuration can be switched between during and outside of business hours of customer service.

### OTHER EMBODIMENTS

This disclosure is not limited to the embodiments described above, and various other embodiments can be realized.

The following steps 1-3 can be executed as the support process of the support processing unit 16.
Step 1 . . . The consultee-side user takes a photograph of the entire musical instrument 2 that is the subject of the consultation matter→share (for example, display on a shared screen window)
Step 2 . . . The consultee-side user takes a (plurality of) photographs of “parts” of the entire musical instrument 2→share (for example, display on a shared screen window)
Step 3 . . . The consultee-side user operates or plays the musical instrument 2 to produce a sound, and records and shares the response of the musical instrument 2 (it is also possible to record when the response differs from the expectation of the consultee-side user)

### Automatic Response to the Sharing of Step 1

Based on a product determination result determined from the overall captured image of the musical instrument 2, instruct which “parts” the consultee-side user should photograph in step 2 (for example, around the nameplate or product number, or around the sound source module in the case of an electronic drum set, etc.). Product determination can be executed based on a product photo DB containing product photos.

In the case of “assembled products” such as drum sets, there can be cases in which the user cannot assemble the item exactly as shown in the product photo DB; therefore, when drums are included in the photo, a drum determination algorithm can be prepared to carry out the determination.

In addition, the specific locations of the “parts” of the overall photo of the musical instrument 2 can be notified to the consultee-side user by displaying superimposed “markers” or the like (the photographing angle can also be indicated). In addition, with digital pianos or similar instruments, there can be objects placed on the unit, and sheet music or a tablet PC can be placed on the music stand. It is also possible to embed into the determination algorithm a process to remove other objects.

### Automatic Response to the Sharing of Step 2

If any of the necessary captured images of the “parts” are missing, photographing and submitting the captured images are notified. The user is notified of specific instructions for “(instrument) sound production” in the subsequent step 3.

### Automatic Response to the Sharing of Step 3

If possible, the support history information 20 and the FAQ information 23 that correspond to the information obtained in steps 1-3 are transmitted to the consultee-side user. Alternatively, connect to the support staff (if within business hours of customer service). If outside of business hours of customer service, the information of steps 1-3 is saved such that the support staff can use the information for support next time. The save location is not limited.

Support progress information indicating whether the problem is smoothly progressing toward a resolution is generated. Information on how each of the steps 1-3 is progressing toward a resolution is obtained. This information can be learned and utilized using AI. For example, it is possible to utilize such information to help determine how much time is necessary to identify the cause, and how long each step is taking.

As applied use, it is also possible to change the form of support. For example, for inexperienced consultee-side users, the support staff initiates the response from the above-mentioned steps 1-3, rather than the automatic responses described above. Such response is also possible.

It is also possible to construct an automatic diagnosis system using the present technique. For example, the response of the musical instrument 2 is recorded and analyzed from the feedback. It is thereby possible to achieve automatic diagnosis, such as “Please play a little” and then “something is wrong here.”

If the musical instrument 2 that is the subject of the consultation matter is an electronic instrument, parameter retrieval (output) and loading (input) can be unified into a single process. In addition, in a situation where a smart device can be connected to the musical instrument 2 by wire or wirelessly, it is also possible to remotely check the model name of the musical instrument 2 and control the current setting parameters. Of course, in such a case, it is possible to require consent of the consultee-side user.

It is possible to accumulate and analyze, to thereby create a database, various information such as support information exchanged from the acquisition of a captured image and information on the consultation matter, to the resolution of the consultation matter. For example, the support history information DB 19 and the FAQ information DB 22 can be updated and constructed. In addition, a defect DB, etc., can be newly constructed.

In addition, information such as usage status of the consultee-side user (installed location, performance location, performance genre, what kind of problems did the user have?) etc., can be accumulated and analyzed as a “usage status database” and utilized for new product development.

It is also possible to link the purchase history, etc., based on the user ID, as illustrated in FIG. 5. In addition, it is also possible to set the system such that support can be prioritized when using an application of the instrument-related support system.

In the embodiment described above, an example was shown in which an application (application program) for using the instrument-related support system 1 is downloaded. That is, an example was shown in which a native application is used in order to use the instrument-related support system 1. Not limited thereto, it is also possible to employ a configuration in which the instrument-related support system 1 is used on a web page displayed in a web browser via a web application. In this case, the trouble of installing an application can be omitted and it becomes possible to avoid problems such as insufficient storage space on the terminal.

In each of the embodiments described above, the server device 7 functions as one embodiment of the information processing device according to this disclosure. Not limited thereto, the function of the server device 7 can be provided in the consultee-side terminal 5, such as the smartphone shown in FIG. 1. In this case, the consultee-side terminal 5 functions as one embodiment of the information processing device according to this disclosure. In addition, the function of the server device 7 can be provided in the support-side terminal 6 such as the laptop computer shown in FIG. 1. In this case, the support-side terminal 6 functions as one embodiment of the information processing device according to this disclosure. Alternatively, some of the functions of the server device 7 can be installed in the consultee-side terminal 5 or the support-side terminal 6.

FIG. 12 is a block diagram showing an example of a hardware configuration of a computer 60 that can be used as the consultee-side terminal 5, the support-side terminal 6, and the server device 7. The consultee-side terminal 5 is provided with an imaging function such as a camera.

The computer 60 includes a CPU 61 as the at least one or more processors, ROM 62, RAM 63, an input/output interface 65, and a bus 64 that connects the foregoing elements to each other. A display unit 66, an input unit 67, a storage unit 68, a communication unit 69, a drive unit 70, and the like are connected to the input/output interface 65.

The display unit 66 is a display device (display) that uses liquid crystal, electroluminescence, etc. The input unit 67 is a user operable input such as a keyboard, a pointing device, a touch panel, or another operation device. If the input unit 67 includes a touch panel, the touch panel can be integrated with the display unit 66.

The storage unit 68 (memory, computer memory) is a non-volatile storage device, such as a HDD, flash memory, or other solid-state memory. The drive unit 70 is a device that can drive a removable recording medium 71, such as an optical recording medium or a magnetic recording tape.

The communication unit 69 is a modem, a router, or another communication device for communicating with other devices that can be connected to a LAN, a WAN, or the like. The communication unit 69 can communicate by wire or wirelessly. The communication unit 69 is often used separately from the computer 60.

Information processing by the computer 60 having the hardware configuration described above is realized by the cooperation between software stored in the storage unit 68, the ROM 62, or the like, and a hardware resource such as the computer 60. Specifically, a program constituting the software stored in the ROM 62 is loaded into the RAM 63 and executed, thereby realizing the information processing method according to this disclosure.

The program is installed onto the computer 60 via the recording medium 71, for example. Alternatively, the program can be installed onto the computer 60 via a global network, etc. Any computer-readable, non-transitory storage medium can be used.

The information processing method (consultation matter solution support method) and program according to this disclosure can be executed as a result of cooperation between a plurality of computers connected so as to be communicable with each other via a network etc., thereby constructing the information processing system and information processing device according to this disclosure.

That is, the information processing method and program according to this disclosure can be executed, not only by a computer system composed of a single computer, but also by a computer system in which a plurality of computers operate in conjunction with each other.

In the present disclosure, a system means a collection of a plurality of constituent elements (devices, modules (components) etc.), regardless of whether all the constituent elements are within the same housing. Accordingly, a plurality of devices housed in different housings and connected to each other via a network, and one device in which a plurality of modules are housed in one housing, are both systems.

Execution of the information processing method and program according to this disclosure realized by a computer system includes both a case in which the acquisition of the captured image of the musical instrument, the acquisition of the information on the consultation matter, the generation of the current status information, the generation and output of the support information, the generation and output of the questionnaire, the acquisition of the response information, and the like, are executed by a single computer, as well as a case in which different computers execute each of the processes. In addition, the execution of each process by a prescribed computer includes causing another computer to execute some or all of the process and acquiring the results thereof.

That is, the information processing method and program according to this disclosure can be applied to a cloud computing configuration in which one function is shared and jointly processed by a plurality of devices via a network.

The instrument-related support system, consultee-side terminal, support-side terminal, server device, various databases, configurations of GUIs for outputting support information, acquisition of information on consultation matters, and each of the process flows such as generation and output of support information, described with reference to the drawings, merely represent one embodiment and can be freely modified within the scope of the spirit of this disclosure. That is, any other configurations or algorithms can be employed for implementing this disclosure.

In the present disclosure, there can be cases in which words such as “substantially,” “almost,” and “approximately” are used, as appropriate, in order to facilitate understanding of the explanation. On the other hand, there is no clearly defined difference between using and not using words such as “substantially,” “almost,” and “approximately.”

That is, in the present disclosure, concepts defining the shape, size, positional relationship, status, etc., such as “center,” “central,” “uniform,” “equal,” “same,” “perpendicular,” “parallel,” “symmetrical,” “extend,” “axial,” “columnar,” “cylindrical,” “ring-shaped,” and “annular” are concepts that include “substantially center,” “substantially central,” “substantially uniform,” “substantially equal,” “substantially same,” “substantially perpendicular,” “substantially parallel,” “substantially symmetrical,” “substantially extend,” “substantially axial,” “substantially columnar,” “substantially cylindrical,” “substantially ring-shaped,” and “substantially annular.”

For example, the foregoing concepts also include states that fall within a prescribed range (e.g., a range of ±10%) based on references such as “perfectly center,” “perfectly central,” “perfectly uniform,” “perfectly equal,” “perfectly same,” “perfectly perpendicular,” “perfectly parallel,” “perfectly symmetrical,” “perfectly extend,” “perfectly axial,” “perfectly columnar,” “perfectly cylindrical,” “perfectly ring-shaped,” “perfectly annular,” etc.

Accordingly, even if words like “substantially,” “almost,” and “approximately” are not used, concepts that would be expressed with the addition of such terms as “substantially,” “almost,” “approximately,” etc. can be included. Conversely, concepts that would be expressed with the addition of such terms as “substantially,” “almost,” “approximately,” etc. do not necessarily exclude perfect states.

In the present disclosure, expressions using “than,” such as “greater than A” and “less than A,” are expressions that comprehensively include both concepts that include cases of being equal to A and concepts that do not include cases of being equal to A. For example, “greater than A” is not limited to cases of excluding being equal to A, but rather includes “greater than or equal to A.” In addition, “less than A” is not limited to “less than A,” but rather includes “less than or equal to A.”

When implementing the present technique, specific settings and other parameters can be appropriately adopted from concepts included in “greater than A” and “less than A” so that the effects described above are achieved.

Of the characteristic features according to this disclosure described above, two or more characteristic features can be combined. That is, the various characteristic features described above in the embodiments can be freely combined without distinction between the embodiments. In addition, the various effects described above are merely examples and are not to be construed as limiting, and other effects can be exhibited.

For example, examples of the information processing system, information processing method, program, and information processing device according to this disclosure include the following configurations.

(1) An information processing system comprising:
a first acquisition unit that acquires a captured image obtained by photographing a musical instrument,
a second acquisition unit that acquires information on a consultation matter relating to the photographed musical instrument,
a current status information generation unit that generates, based on the captured image, current status information relating to the current status of the musical instrument, including information relating to at least one or more of configuration of the musical instrument, state of the musical instrument, or installed location of the musical instrument, and
a support processing unit that generates and outputs support information for resolving the consultation matter based on the information on the consultation matter and the current status information.

(2) The information processing system according to (1), wherein
the second acquisition unit acquires information on a consultation matter relating to a function of the musical instrument.

(3) The information processing system according to (2), wherein
the support processing unit generates and outputs a support image for resolving the consultation matter.

(4) The information processing system according to (3), wherein
the support processing unit outputs the support image superimposed on the captured image or on a model image of the musical instrument.

(5) The information processing system according to (2), wherein
the support processing unit generates and outputs shooting guide information for guiding photography of the musical instrument.

(6) The information processing system according to (2), further comprising
a storage unit that stores, as support history information, information including the captured image, the information on the consultation matter, the current status information, and the support information.

(7) The information processing system according to (2), wherein
the first acquisition unit acquires, as the captured image, a performance image in which a player is playing the musical instrument and/or an image including a peripheral device used when playing the musical instrument.

(8) The information processing system according to (2), wherein
the information relating to the configuration of the musical instrument includes at least one piece of information of type, model, product number, and year.

(9) The information processing system according to (2), wherein
the information relating to the state of the musical instrument includes setting state and/or parameter setting state.

(10) The information processing system according to (2), wherein
information relating to the installed location of the musical instrument includes information on whether the installed location is indoors or outdoors.

(11) An information processing method executed by a computer system, the method comprising:
acquiring a captured image obtained by photographing a musical instrument,
acquiring information on a consultation matter relating to the photographed musical instrument,
generating, based on the captured image, current status information relating to the current status of the musical instrument, including information relating to at least one or more of a configuration of the musical instrument, state of the musical instrument, or installed location of the musical instrument, and
generating and outputting support information for resolving the consultation matter based on the information on the consultation matter and the current status information.

(12) A program that causes a computer system to execute the steps of:
acquiring a captured image obtained by photographing a musical instrument,
acquiring information on a consultation matter relating to the photographed musical instrument,
generating, based on the captured image, current status information relating to the current status of the musical instrument, including information relating to at least one or more of configuration of the musical instrument, state of the musical instrument, or installed location of the musical instrument, and
generating and outputting support information for resolving the consultation matter based on the information on the consultation matter and the current status information.

(13) An information processing device, comprising:
a first acquisition unit that acquires a captured image obtained by photographing a musical instrument,
a second acquisition unit that acquires information on a consultation matter relating to the photographed musical instrument,
a current status information generation unit that generates, based on the captured image, current status information relating to the current status of the musical instrument, including information relating to at least one or more of a configuration of the musical instrument, state of the musical instrument, or installed location of the musical instrument, and
a support processing unit that generates and outputs support information for resolving the consultation matter based on the information on the consultation matter and the current status information.

What is claimed is:

1. An information processing system comprising:
a processor configured to execute a plurality of units that include
a first acquisition unit configured to acquire a captured image obtained by photographing a musical instrument,
a second acquisition unit configured to acquire information on a consultation matter relating to a function of the musical instrument,
a current status information generation unit configured to generate, based on the captured image, current status information relating to a current status of the musical instrument, the current status information including information relating to at least one or more of a configuration of the musical instrument, state of the musical instrument, or installed location of the musical instrument, and
a support processing unit configured to generate and output support information for resolving the consultation matter based on the information on the consultation matter and the current status information.

2. The information processing system according to claim 1, further comprising
a memory that stores at least one or both of
support history information including information on consultation matters acquired previously and support information generated and output previously to resolve the consultation matters, or
FAQ (Frequently Asked Questions) information containing information on consultation matters and support information that are created in advance, wherein
the support processing unit is configured to search the at least one or both of the support history information or the FAQ information, and output a search result.

3. The information processing system according to claim 1, wherein
the information on the consultation matter includes at least one or more of
a consultation matter relating to sounds generated by the musical instrument,
a consultation matter relating to a movement during playing of the musical instrument,
a consultation matter relating to a setting of the musical instrument,
a consultation matter relating to a malfunction of the musical instrument,
a consultation matter relating to maintenance of the musical instrument, or
a consultation matter relating to an expansion function of the musical instrument.

4. The information processing system according to claim 1, wherein
the captured image contains sound information,
the first acquisition unit is configured to acquire information on performance sounds of the musical instrument, and
at least one or both of generation of the current status information by the current status information generation unit based on the information on the performance sounds or generation of the support information by the support processing unit based on the information on the performance sounds is executed.

5. The information processing system according to claim 1, wherein
the support processing unit is configured to generate and output a procedure image for instructing a procedure to be followed with respect to the musical instrument.

6. The information processing system according to claim 1, wherein
the processor is further configured to execute a questionnaire unit configured to output a questionnaire relating to the consultation matter and acquire response information in response to the questionnaire, and
at least one or both of generation of the current status information by the current status information generation unit based on the response information or generation of the support information by the support processing unit based on the response information is executed.

7. The information processing system according to claim 1, wherein
the current status information generation unit is configured to generate the current status information further based on the information on the consultation matter.

8. The information processing system according to claim 1, wherein
the support processing unit is configured to generate and output, as shooting guide information for guiding photography of the musical instrument, information instructing at least one or more of a shooting location relative to the musical instrument, a shooting angle relative to the musical instrument, or a number of photographs to be taken of the musical instrument.

9. The information processing system according to claim 1, wherein
the support processing unit is configured to generate progress information relating to a progress of support for resolving the consultation matter.

10. The information processing system according to claim 1, wherein
the support processing unit is configured to output link information to a web page for resolving the consultation matter.

11. The information processing system according to claim 1, wherein
the support processing unit is configured to output instruction information for instructing performance of the musical instrument.

12. The information processing system according to claim 1, wherein
the second acquisition unit is configured to acquire the information on the consultation matter based on at least one or both of input information input by a user or the captured image.

13. An information processing method executed by a computer system, the method comprising:
acquiring a captured image obtained by photographing a musical instrument;
acquiring information on a consultation matter relating to a function of the musical instrument;
generating, based on the captured image, current status information relating to a current status of the musical instrument, the current status information including information relating to at least one or more of a configuration of the musical instrument, state of the musical instrument, or installed location of the musical instrument; and
generating and outputting support information for resolving the consultation matter based on the information on the consultation matter and the current status information.

14. A non-transitory computer-readable storage medium storing an information processing program that causes a computer system to perform an information processing method, the information processing method comprising:
acquiring a captured image obtained by photographing a musical instrument;
acquiring information on a consultation matter relating to a function of the photographed musical instrument;
generating, based on the captured image, current status information relating to a current status of the musical instrument, the current status information including information relating to at least one or more of a configuration of the musical instrument, state of the musical instrument, or installed location of the musical instrument; and
generating and outputting support information for resolving the consultation matter based on the information on the consultation matter and the current status information.
